(19) United States
(12) Patent Application Publication
(10) Pub. No.: US 2021/0291979 A1
(43) Pub. Date: Sep. 23, 2021

(54) Unmanned Aircraft, Control Method, Associated Platform and High-Altitude Turbine

(71) Applicant: SKYPULL SA, DINO - LUGANO (CH)

(72) Inventors: Aldo CATTANO, Porto Valtravaglia (VA) (IT); Alberto BETTELINI, Caslano (CH); Nicola MONA, Mendrisio (CH)

(21) Appl. No.: 17/259,344

(22) PCT Filed: Jul. 12, 2019
(86) PCT No.: PCT/IB2019/055959

§ 371 Date: Jan. 11, 2021

(30) Foreign Application Priority Data
Jul. 13, 2018 (IT) 102018000007202

(51) Int. Cl. B64C 39/02; F03D 5/04

(52) U.S. Cl. CPC B64C 39/022; B64C 39/024; F03D 5/04; F05B 2240/923; B64C 2201/165; B64C 2201/042; F05B 2240/921; B64C 2201/027

(57) ABSTRACT

Unmanned aircraft, comprising a first wing (11) and a second wing (12), wherein at least one of the first and second wings (11, 12) are made with a multiple element configuration comprising a set of wing profiles (21, 22, 23, 24) which are arranged at least partially in a condition of mutual proximity, said set of wing profiles comprising at least a first wing profile (21) and a second wing profile (22) which are mutually positioned one after the other and which define a leading edge and a trailing edge, respectively, wherein said first wing (11) and said second wing (12) are spaced with respect to each other; said aircraft further comprising interconnection supports (13, 14) between said first wing (11) and said second wing (12), holding said first and second wing (11, 12) at a given distance, said unmanned aircraft further comprising at least one aerodynamic container (40) positioned between said first wing (11) and said second wing (12), said aerodynamic container (40) comprising an inner compartment and a casing enclosing said inner compartment and being adapted and configured to carry a load and/or a central motor (50c).

### FIELD OF THE INVENTION

The invention relates to the aircraft sector and in detail it relates to an unmanned aircraft. The invention also relates to a method of controlling an aircraft, in particular an unmanned aircraft. The invention also relates to a base for said aircraft. The invention also comprises an electricity production system, which exploits the unmanned aircraft object of the invention.

### PRIOR ART

For some time now the use of drones, i.e. of unmanned aircraft, has become widespread for the most varied applications.

Some drones are VTOL aircraft, i.e. vertical take-off. These aircraft are used where there is a real need for take-off and landing in very small spaces. These drones alternatively need separate motors between the translated flight and the vertical take-off, or rotating motors to adapt to the passage from the vertical take-off to the translated flight. Such rotating motors are typically installed on a gondola where the engine and propeller are housed; the whole gondola rotates with the aid of a fifth wheel and a motor necessary for the rotation.

Vertical take-off aircraft thus built have some drawbacks. In detail, a first drawback is the fact that having separate motors increases the production costs and the complexity of managing the aircraft, as well as its dimensions, and it is difficult to regulate the transition from vertical take-off to translated flight. Conversely, the use of rotating motors is disadvantageous since the control and rotation system of the motors may be subject to malfunctions as a result of which it is for example impossible to switch from the translated flight configuration to the hovering or landing configuration. In the latter case, the flying drone is substantially lost.

Furthermore, it is known that wind turbines are used in the field of electricity production. Such turbines exploit the kinetic energy made available to the shaft of the turbine itself and in turn converted into electricity by an electric generator. Electricity production plants using wind turbines mounted on towers are distinguished, in addition to the total power generated, essentially in plants that use horizontal axis turbines and plants that use vertical axis turbines.

The Applicant has observed that, for aircraft in general and in particular for Vtol aircraft, low speeds are the most critical, because they correspond to landing and take-off, therefore in the proximity of the ground where the turbulences are greater so it is desirable to have a greater maneuverability and lift to oppose turbulence. The use of rotating motors shows a limit in particular in the delicate take-off and landing steps.

Particular attention was also paid during take-offs and landings of vertical take-off aircraft in adverse weather conditions. In particular, when the aircraft are characterized by small size and low weight, as in the case of drones, gusts of wind, prevailing winds in particular directions and turbulence can significantly compromise the flight stability of the drone, with the real risk of loss of control, even if the aircraft is equipped with complex avionic automatic or semi-automatic aircraft stability control systems.

Solutions are known for the exploitation of high-altitude winds, which are based on an aerial vehicle equipped with propellers and motors—generators in which the propellers are initially driven by the motor—generator supplying electricity from the network to bring the aircraft up high and in which, subsequently, the same propellers are used to produce electricity by exploiting the winds at high altitude. The energy is produced, therefore, at high altitude and is transmitted to ground by an electric cable which connects the aerial vehicle to the ground. Solutions are known for the exploitation of high-altitude winds which are based on an aerostatic balloon internally provided with a rotor and a generator. Also in this case, energy production takes place at an altitude and the energy is transmitted to ground by means of an electric cable which connects the aerostatic balloon to the ground. Solutions are known for the exploitation of high-altitude winds which are based on an aerial vehicle which is brought at high altitude and which is connected to the ground by an anchoring cable which is alternately released and recovered to operate the generators positioned on the ground. The Applicant realized that the availability and constancy of the winds at altitude is significantly better than that at low altitude. Consequently, to optimize the production of electricity, it is convenient to use generation systems in which the acquisition of electricity takes place at high altitudes. In compliance with all of the above, the need has been found to obtain an unmanned aircraft capable of solving the aforementioned drawbacks, and in particular of being able to operate as a vertical take-off aircraft capable of taking off and flying even in conditions of adverse weather and of operating as a multi-role aircraft.

A further object of the present invention is to describe a wind plant, with unmanned aircraft controlled from the ground, capable of operating effectively for the production of electricity.

A further object of the present invention is to describe a base for an aircraft, in particular for an unmanned aircraft, capable of being conveniently used in order to allow such an aircraft to take off more easily and/or safely even in adverse weather conditions.

A further object of the present invention is to describe a control method of an unmanned aircraft capable of solving the aforementioned drawbacks.

### SUMMARY OF THE INVENTION

These and further objects are achieved by an unmanned aircraft, and/or by a wind plant, and/or by a base and/or by an aircraft control method according to the following aspects.

According to a first aspect, an aircraft is described, in particular an unmanned aircraft, comprising a first wing (11) and a second wing (12), wherein at least one of the first and second wings (11, 12) are made with a multiple element configuration comprising a set of wing profiles (21, 22, 23, 24) which are arranged at least partially in a condition of mutual proximity, said set of wing profiles comprising at least a first wing profile (21) and a second wing profile (22) which are mutually positioned one after the other and which define a leading edge and a trailing edge, respectively, wherein said first wing (11) and said second wing (12) are spaced with respect to each other; said aircraft further comprising interconnection supports (13, 14) between said first wing (11) and said second wing (12), holding said first and second wing (11, 12) at a given distance,

said unmanned aircraft further comprising at least one aerodynamic container (40) positioned between said first wing (11) and said second wing (12), said aerodynamic container (40) comprising an inner compartment and a casing enclosing said inner compartment and being adapted and configured to carry a load and/or a central motor (50c).

According to a further non-limiting aspect, the aircraft comprises at least one tie rod or connecting element (41) for said aerodynamic container (40), said tie rod or connecting element (41) comprising a first portion fixed to at least one between said first wing (11), said second wing (12), or an interconnection support (13, 14) and a second portion, distinct from said first portion, fixed to said aerodynamic container.

According to a further non-limiting aspect, the interconnection supports (13, 14) are and/or comprise a first interconnection support (13) and a second interconnection support (14).

According to a further non-limiting aspect, the first portion is a first end of said tie rod or connecting element (41) and the second portion is a second end of said tie rod or connecting element (41) opposite to said first end.

According to a further non-limiting aspect, said aerodynamic container (40) comprises a fixed central motor (50c).

According to a further non-limiting aspect, said plurality of motors (50) and/or said fixed central motor (50c) are fixed with respect to at least part of said first wing (11), of said second wing (12), of said first interconnection support (13) and of said second interconnection support (14) and/or said plurality of motors (50) and/or said fixed central motor (50c) are parallel to each other.

According to a further non-limiting aspect, said aerodynamic container is fixedly installed with respect to said first wing (11) and/or said second wing (12) and/or with respect to the interconnection support (13, 14) and/or with respect to the aircraft structure.

According to a further non-limiting aspect, said interconnection supports (13, 14) are two and comprise a first interconnection support (13) and a second interconnection support (14), said first and second interconnection support being inclined, in particular being arranged orthogonally, with respect to said first wing (11) and second wing (12) and wherein said aerodynamic container (40) is positioned between said first wing (11), said second wing (12), and said first support interconnection (13) and said second interconnection support (14).

According to a further non-limiting aspect, said first and said second interconnection support (13; 14) each comprise a first portion, optionally a first end, fixed at a first end of the first wing (11) and at a second end of the first wing (11), respectively, opposite to the first end, and a second portion, optionally a second end opposite the first end, fixed at a first end of the second wing (12) and at a second end of the second wing (12), respectively, opposite to the first end.

According to a further non-limiting aspect, said at least one aerodynamic container (40) has a main development along a predetermined direction, in particular a direction coinciding and/or substantially coinciding with the advancement direction which the aircraft (1) takes in use.

According to a further non-limiting aspect, said aircraft comprises a plurality of aerodynamic containers (40) having a cavity or space therein configured to transport loads in use.

According to a further non-limiting aspect, the aircraft further comprises a plurality of tie rods or connecting elements (41) each having a first end fixed at a junction point between said first interconnection support (13) or said second interconnection support (14) and the respective portion or end of the first wing (11) or of the second wing (12), respectively, and a second end, opposite to the first end, fixed to said aerodynamic container (40).

According to a further non-limiting aspect, the plurality of tie rods or connecting elements (41) are arranged so as to make said aerodynamic container (40) take a substantially central and/or substantially barycentric position between said first wing (11), said second wing (12), said first interconnection support (13) and said second interconnection support (14). According to a further non-limiting aspect, said tie rods or connecting elements (41) are crossed with each other, and in particular they form four arms which depart from said aerodynamic container (40).

According to a further non-limiting aspect, the aircraft (1) comprises a plurality of motors (50), optionally a plurality of electric machines having a rotor axially fixed to a propeller (51).

According to a further non-limiting aspect, in correspondence of said first wing (11) and said second wing (12) a plurality of electrical machines are present, comprising a rotor axially fixed to a propeller (51).

According to a further non-limiting aspect, the aircraft (1) comprises at least four motors (50) installed in a fixed and peripheral manner on said first wing (11) and on said second wing (12).

According to a further non-limiting aspect, said aircraft (1) also comprises a central motor (50c), optionally in addition to said at least four motors (50) installed in a fixed and peripheral manner on said first wing (11) and on said second wing (12)

According to a further non-limiting aspect, said central motor (50c) and/or said plurality of motors (50) comprises a plurality of electric motors whose rotor is fixed to a propeller (51) and wherein said at least one first and a second wing profile are positioned behind said propeller (51) with respect to an advancement direction of said aircraft.

According to a further non-limiting aspect, said propeller (51) is located frontally with respect to the leading edge of said first wing (11) and/or of said second wing (12).

According to a further non-limiting aspect, the aircraft comprises a first operating, take-off and/or landing configuration, and a second operating configuration, of translated flight, wherein in said first operating configuration the propellers (51) of each of the motors (50) have an axis of rotation inclined with respect to the vertical axis, although close to being vertical and/or the longitudinal axis of said aircraft is close to being vertical.

According to a further non-limiting aspect, said aircraft is configured to take off upwind and/or the first operating configuration, take-off and/or landing, is an operating configuration of take-off and/or landing upwind, wherein the axis of rotation of the propellers is facing the direction of origin of the wind.

According to a further non-limiting aspect, said propeller (51) is a driving propeller configured to produce, in at least a predefined condition of use, an accelerated air flow that touches and/or impinges the profile of said first wing (11) and/or said second wing (12), optionally causing, substantially at said at least one first wing (11) and/or said second wing (12), an air flow of greater speed than the speed at which said aircraft moves, and/or configured to generate a lift on said first wing (11) and/or second wing (12).

According to a further non-limiting aspect, said aircraft comprises an operating configuration in which at least part of said plurality of motors (50) and/or said central motor (50c) is configured to exert an airbrake action, optionally by means of a braking action caused by a rotation of the propellers according to the motion direction of the aircraft. In particular, the airbrake operating configuration takes place during the translated flight operating configuration.

According to a further non-limiting aspect, in said operating configuration, said motors (50) are controlled independently so as to each generate a variable braking force, and said aircraft is configured to perform a trajectory along a curve in use at least partially, optionally completely, followed through the variable braking action of said motors (50).

According to a further non-limiting aspect, said first wing (11) and/or said second wing (12) comprise a first wing portion and a second overlapping wing portion, in particular overlapping along a direction substantially orthogonal to a direction of advancement and/or comprising at least one intrados or an extrados and wherein the overlap occurs along the direction substantially identified by an ideal line joining the intrados or extrados of the first wing portion with the intrados or extrados of the second wing portion.

According to a further non-limiting aspect, said first wing (11) and/or said second wing (12) each comprising a plurality of dividing walls, optionally equally spaced, interposed between said first and said second wing.

According to a further non-limiting aspect, said aerodynamic container (40) integrates sensors and/or navigation and/or telemetry systems.

According to a further non-limiting aspect, said aircraft (1) comprises at least a first operating movement configuration substantially in vertical and/or hovering direction, in particular at take-off and/or at landing, and at least a second operating configuration of translated flight, wherein in said first operating configuration said direction of advancement is substantially vertical, and wherein in said second operating configuration the direction of advancement is substantially longitudinal and/or comprises a longitudinal component.

According to a further non-limiting aspect, in said second configuration said aircraft is self-stabilizing.

According to a further non-limiting aspect, said aircraft (1) is a vertical take-off aircraft.

According to a further non-limiting aspect, said first interconnection support and/or said second interconnection support (13; 14) integrate movable surfaces (13t, 14t) comprising ailerons or rudders or flaps.

According to a further non-limiting aspect, said aircraft comprises at least one bridle connected to a retaining cable (18).

According to a further non-limiting aspect, said retaining cable (18) has a predetermined weakening point.

According to a further non-limiting aspect, said aircraft comprises a plurality of bridles, optionally installed at end portions of said first wing (11) and of said second wing (12). According to a further non-limiting aspect, the aircraft comprises 2 or 4 bridles.

According to a further non-limiting aspect, said at least one bridle or said plurality of bridles is removably connected to said retaining cable (18).

According to a further non-limiting aspect, said first interconnection support and/or said second interconnection support (13, 14) comprise a leading edge and said movable surfaces (13t, 14t) are positioned rearwardly with respect to said leading edge.

According to a further non-limiting aspect, said first interconnection support and/or said second interconnection support (13, 14) are rigid supports, optionally of substantially wing shape.

According to a further non-limiting aspect, said first and/or said second wing are provided with movable surfaces positioned in a rear position with respect to said leading edge.

According to a further non-limiting aspect, said aircraft comprises a motor adapted to rotate at least part of said retaining cable (18), wherein—optionally—said motor comprises at least a portion fixed in correspondence of and/or on said retaining cable (18).

According to a further non-limiting aspect, said movable surfaces are configured to modify the flow produced by said motors (50) when activated.

According to a further non-limiting aspect, said first interconnection support (13) and said second interconnection support (14) integrate a set of wing profiles which are arranged at least partially in a condition of mutual proximity, optionally along a direction of advancement of said aircraft.

According to a further non-limiting aspect, at least one and more preferably each of said motors (50; 50c) has a variable pitch propeller (51), in particular variable between at least a first and smaller pitch and a second and greater pitch, and wherein in said first operating configuration said propeller (51) takes at least the first and smaller pitch and in said second operating configuration said propeller (51) takes the second and greater pitch.

According to a further non-limiting aspect, said propeller (51) is a folding propeller.

According to a further non-limiting aspect, said motors (50) are at least four, fixed, peripheral and controlled or controllable independently of one another.

According to a further non-limiting aspect, said aircraft comprises at least one measurement device for wing warping and/or deformation, installed at said first wing (11) and/or second wing (12) and/or said first and/or said second interconnection support (13; 14), said wing warping and/or deformation measurement device being or optionally comprising a strain gauge.

According to a further non-limiting aspect, at least part of said aircraft is lined with and/or made of a material that is visible to the infrared and/or reflecting the infrared and/or visible for or reflecting wavelengths greater than 600 nm, more preferably 700 nm and/or is characterized by night visibility.

In particular, according to a further non-limiting aspect, the retaining cable (18) has infrared visibility and/or infrared reflection properties and/or visibility or reflection of wavelengths greater than 600 nm, more preferably 700 nm and/or has by night visibility.

According to a further non-limiting aspect, said warping and/or deformation measurement device is adapted to detect a force and/or a warping of a movable portion of said first wing (11) and/or of said second wing (12).

According to a further non-limiting aspect, said aircraft (1) takes a substantially box-like shape and/or defines a shape with two-by-two parallel sides, said sides being defined by said first wing (11), said second wing (12), said first interconnection support (13) and said second interconnection support (14).

According to a further non-limiting aspect, said first wing (11) is offset with respect to said second wing (12) and develops substantially on a plane parallel and/or substantially parallel to the plane on which the second wing (12) develops.

According to a further aspect, an aircraft is described, in particular an unmanned aircraft, comprising a first wing (11) and a second wing (12), wherein at least one of the first and second wings (11, 12) are made with a multiple element configuration comprising a set of wing profiles (21, 22, 23, 24) which are arranged at least partially in a condition of mutual proximity, said set of wing profiles comprising at least a first wing profile (21) and a second wing profile (22) which are mutually positioned one after the other and which define a leading edge and a trailing edge, respectively, wherein said first wing (11) and said second wing (12) are spaced with respect to each other; said aircraft further comprising interconnection supports (13, 14) between said first wing (11) and said second wing (12), holding said first and second wing (11, 12) at a given distance, said aircraft comprising a plurality of motors (50), optionally a plurality of electric machines having a rotor axially fixed to a propeller (51) and/or wherein at said first wing (11) and said second wing (12) a plurality of electric machines are present, comprising a rotor axially fixed to a propeller (51), wherein said propeller (51) is a driving propeller configured to produce, in at least a predefined condition of use, an accelerated air flow that touches and/or impinges the profile of said first wing (11) and/or said second wing (12), optionally causing, substantially at said at least one first wing (11) and/or said second wing (12), an air flow of greater speed than the speed at which said aircraft moves, and/or configured to generate a lift on said first wing (11) and/or second wing (12).

According to a further aspect of the invention, an electricity production plant is provided, characterized in that it comprises:
at least one carriage (8) or a tracted device, movable along a guide (2) on a predefined path by means of the action of an aircraft (1) placed at altitude and subjected to the action of the wind;
a retaining cable (18) having a first portion configured to be connected to said aircraft (1) and a second portion connected to said carriage (8);
wherein said carriage (8) comprises electric generators (27, 28) adapted to produce electricity from the movement of said carriage (8) along said predefined path;
wherein said aircraft (1) is an aircraft according to one or more of the preceding aspects.

According to a further aspect of the invention, a base for an unmanned aircraft (1) is provided, said base (100) comprising a support platform (101) for said aircraft (1) and a supporting frame adapted to space said support platform from the ground, said supporting frame comprising at least one base (103); said base being characterized in that said platform (101) is movable with respect to said base (103).

According to a further non-limiting aspect, said base (100) is a base for an aircraft according to the present description, in particular designed to cooperate with an aircraft according to the present description.

According to a further non-limiting aspect, said platform (101) is movable by rotation relative to said base (103) and/or configured to take a plurality of controlled inclinations with respect to said base (103).

According to a further non-limiting aspect, the platform (101) is rotatably installed with respect to the base (103), in particular in such a way as to be able to rotate relatively around an axis which extends in a substantially vertical direction.

According to a further non-limiting aspect, the platform (101) is idly installed with respect to the base (103).

According to a further non-limiting aspect, said base (100) comprises a plurality of lateral supports (102) for separating said platform (101) and said base (103), adapted to distance the platform from the base by a predefined height.

According to a further non-limiting aspect, the base comprises a dome closure element, having at least one first open configuration and one second closed configuration, wherein in said first open configuration the closure element leaves the aircraft free to take off or land on the platform (101).

According to a further non-limiting aspect, each of the lateral supports (102) has a substantially aerodynamic shape, with surfaces extending along a plane comprising such an axis which extends in a substantially vertical direction and/or has a substantially vertically oriented wing shape, which in use, under the effect of the wind, allows the platform (101) to be aligned, by rotation relative to the base (103), with the wind direction.

According to a further non-limiting aspect, said base comprises servo actuators configured to perform said rotation relative to the base (103) and/or to allow or cause the taking of a plurality of inclinations with respect to said base (103), wherein said actuators are configured to receive an actuation signal from wind meters, optionally from wind direction meters, and in particular to position said platform (101) upwind on the base of said actuation signal and/or according to at least one wind direction identified by said meters.

According to a further non-limiting aspect, said base integrates a winch or drum (106) and a retaining cable (18) at least partially wound on said drum (106) and a motor (105) acting in rotation on said drum (106) for the controlled unwinding or rewinding of said retaining cable (18), said retaining cable (18) having in use at least one portion removably connected to said aircraft (1).

According to a further aspect, said aircraft comprises a retaining cable (18).

According to a further non-limiting aspect, said base integrates a tubular element (107), optionally a telescopic tube (107), extending obliquely with respect to said platform (101) and on which and/or within which and/or with respect to which said retaining cable (18) is made to slide or slides.

According to a further non-limiting aspect, said tubular element (107) is a damping element for said retaining cable (18) and/or for the tension of said retaining cable (18).

According to a further non-limiting aspect, said retaining cable (18) is a cable with low aerodynamic resistance and/or provided, for at least a portion thereof, with a lateral surface at least partially, more preferably integrally, covered with concavities or recesses adapted to favor the reduction of the aerodynamic resistance of the cable itself and/or is provided with at least a portion comprising a helical and/or a Savonius turbine-shaped surface.

According to a further non-limiting aspect, said retaining cable (18) is a cable at least partially rotating with respect to its own development axis (K), and in particular said portion having said helical and/or Savonius turbine-shaped surface is rotating.

According to a further non-limiting aspect, said retaining cable (18) is retained, at a portion thereof, in particular end, with a rotating bearing.

According to a further non-limiting aspect, said aircraft comprises a motor adapted to rotate at least part of said retaining cable (18).

According to a further non-limiting aspect, said base (100) is characterized by the presence of an inertial measurement unit, positioned at or substantially at said tubular element (107), optionally at a free end of said tubular element (107), said inertial measurement unit being configured and/or specifically designed and/or adapted to detect forces and/or loads, in particular bending forces and/or loads, on said tubular element (107).

According to a further non-limiting aspect, said base (100) is characterized by the presence of a strain gauge or load cell, positioned at or substantially at said tubular element (107), optionally at a free end of said tubular element (107).

According to a further non-limiting aspect, said base integrates an electrically connected data processing unit and/or operatively configured at least to receive data, in particular data relating to said forces and/or loads, from said inertial measurement unit and to transmit, also indirectly, an actuation signal of said motor (105), optionally for the release and/or unwinding of said retaining cable (18).

According to a further aspect of the invention, an electricity production plant is provided, characterized in that it comprises:
a base (100) according to one or more of the preceding aspects,
an aircraft (10) according to one or more of the preceding aspects, and
a retaining cable (18) having a first portion configured to be connected to said aircraft (1);
a drum on which said retaining cable (18) is wound in a second portion thereof;
generating means for producing electricity, removably connected to said retaining cable (18) and/or to the drum on which said retaining cable (18) is connected, adapted to generate electricity from or through the unwinding and/rewinding of said retaining cable (18) on said drum by the action of a dragging force, at least temporary, exerted by the aircraft (10) on said retaining cable (18).

According to a further non-limiting aspect, said base (100) is fixedly installed with respect to the ground.

According to a further non-limiting aspect, said retaining cable (18) is electrically insulating.

According to a further non-limiting aspect, said generating means comprise a rotor rigidly connected to said drum.

According to a further aspect of the invention, a method of controlling an unmanned aircraft (1) is provided, the method comprising:
an activation step of at least one motor (50) of a plurality of motors (50) of said aircraft (1) in a first vertical take-off operating configuration or first flight attitude, starting from a support platform (101),
a step of adjusting the power generated by said plurality of motors (50) to cause a change of said first flight attitude in a further or second flight attitude identifying a second operating configuration of the aircraft (1) in which it proceeds in translated flight with a horizontal translation component, wherein
the step of adjusting the power generated by said plurality of motors (50) causes an alteration of the spatial orientation of the structure of said aircraft (1).

According to a further non-limiting aspect, said aircraft (1) is an aircraft according to one or more of the present aspects.

According to a further non-limiting aspect, said alteration of the spatial orientation of the structure of said aircraft (1) and/or the mutation between the first and the second attitude take place by means of motors (50) rigidly joined to the structure of said aircraft (1).

According to a further non-limiting aspect, the method comprises a control step of said second flight attitude wherein at least part of said motors (50) acts as an airbrake for said aircraft, optionally wherein said control step comprises an independent control of said motors (50).

According to a further non-limiting aspect, said control step in which at least part of said motors acts as an airbrake comprises maintaining the rotation of the propeller (51) of each motor used as an airbrake according to the direction of advancement of the aircraft and/or comprises a braking of the propeller (51) of each motor used as an airbrake.

According to a further non-limiting aspect, the method comprises the control of the aircraft in said second flight attitude by means of a plurality of bridles connected at different points of the aircraft and in particular at end points of said first wing (11) and/or second wing (12), and7or at said plurality of bridles being connected to a first end of a retaining cable (18) fixed to a ground support at a predefined portion thereof, optionally at an opposite end thereof with respect to said first end.

According to a further non-limiting aspect, said method comprises a step of performing a turn and/or pitch and/or roll by the actuation of movable surfaces (13t, 14t) of at least one interconnection support (13; 14) which connects a first wing (11) with a second wing (12) of the aircraft.

According to a further non-limiting aspect, the method comprises a step of progressive release of the retaining cable (18), by means of a partial unwinding of the latter from a drum, alternated with and/or followed by a step of at least partial rewinding of the retaining cable (18) on the drum, wherein at least during the partial unwinding a generator connected to the drum on which the retaining cable is wound causes the production of electricity.

According to a further non-limiting aspect, the at least partial unwinding step is passive, and is caused by the pulling action that the aircraft (1) exerts on the retaining cable (18) due to the wind.

According to a further non-limiting aspect, the method comprises a step of controlling and/or varying the pitch of propellers of said motors (50) according to the operating configuration of the aircraft, wherein the control step provides for an increase in the pitch of at least one of the propellers of motors in the transition from the first operating configuration to the second operating configuration and/or from the first flight attitude to the second flight attitude.

According to a further non-limiting aspect, the control method of the aircraft provides for having a minimum pitch for said propellers during the take-off and/or landing steps of the aircraft itself.

According to a further non-limiting aspect, the method provides a remote and/or automatic control step of the aircraft (1) by varying and/or adjusting the power supplied by each of the motors (50, 50c).

According to a further non-limiting aspect, said plurality of motors is a plurality of independently controllable motors (50, 50c).

According to a further non-limiting aspect, the method provides for said aircraft to perform controlled turns (1) to describe an “8” and/or circular and/or curved trajectory in particular during an active electricity generation step.

According to a further non-limiting aspect, the method provides a verification step, preferably electronic and/or automatic, of the lift that at least the first wing (11) and the second wing (12) exert on the aircraft (1), and, if such lift is sufficient to keep the aircraft 1 in flight without the aid of the power supplied by the motors (50, 50c), the method comprises a step of positioning the propellers so as to have zero and/or flag angle of incidence.

According to a further non-limiting aspect, said method comprises an automated control of the trajectory of said aircraft (1) by means of a transmission of flight data between a data processing unit on the ground and said aircraft (1), in particular a data processing unit installed on board the aircraft (1).

According to a further non-limiting aspect, said method comprises a step of controlling and/or damping the load peaks produced by the gusts of wind and/or of maintaining a constant lift on said aircraft (1).

According to a further non-limiting aspect, said control and/or damping is a control and/or damping automatically carried out by or through a data processing unit.

According to a further non-limiting aspect, said control in particular comprises measuring the load and/or lift capacity produced on the first wing (11) and/or second wing (12) and/or first interconnection element (13) and/or second interconnection element (14), preferably but not limited to by means of at least one strain gauge or force meter.

According to a further non-limiting aspect, following said load and/or lift measurement, said method comprises a correction, preferably automatic, of the movable surfaces of said first wing (11) and/or second wing (12) and/or first interconnection element (13) and/or second interconnection element (14), in particular a control aimed at increasing the incidence on the lift made by said movable surfaces if the load and/or lift measurement decreases with respect to a predetermined value, and a decrease in the incidence on the lift made by said movable surfaces if the load and/or lift measurement increases with respect to the aforementioned predetermined value.

According to a further non-limiting aspect, said method comprises a controlled release step of the retaining cable (18) from said aircraft, optionally during the execution of an emergency maneuver; said release step occurring with a disconnection of said retaining cable (18) from the aircraft (1) at an end portion of said retaining cable (18) close to said aircraft (1), optionally at the junction with bridles connected at the joining points between the first wing (11) or the second wing (12) with respective first, second interconnection element (13, 14), and/or occurring by means of a remote release control.

According to a further non-limiting aspect, following said controlled release step, an at least partial rewinding step of said retaining cable (18) on a winding drum is performed, optionally automatically.

### DESCRIPTION OF THE FIGURES

These and further features of the invention will be further described with reference to one or more preferred and non-limiting embodiments, to which the following description portion refers and with reference to the accompanying figures, in which:

FIG. 1 shows a perspective view of a first embodiment of an unmanned aircraft, object of the invention;

FIG. 2 shows a lateral view of the aircraft in FIG. 1;

FIG. 3 shows a bottom view of the aircraft in FIG. 1;

FIG. 4 shows a bottom view of a second embodiment of the aircraft object of the invention;

FIG. 5 shows a lateral view of the aircraft in FIG. 4;

FIG. 6 shows a detail of a plant for producing electricity by means of an aircraft according to the invention;

FIG. 7 shows a further detail of part of the plant in FIG. 6, in particular a carriage, useful for the production of electricity;

FIG. 8 shows a further detail of part of the plant in FIG. 6 and FIG. 7;

FIG. 9 shows a trajectory that said aircraft can take for the production of electricity;

FIG. 10 and FIG. 11 show respective details of a ground-based generator and a base for the aircraft object of the invention; and

FIG. 12 shows a detailed view of two portions of a retaining cable to which the aircraft of the invention is connected.

### DETAILED DESCRIPTION OF THE INVENTION

The reference numeral 1 indicates as a whole an unmanned aircraft or aerial device, which in the present description is presented in two non-limiting embodiments.

In both embodiments, the aircraft object of the invention is configured to have at least a first operating movement configuration substantially in vertical and/or hovering direction, in particular at take-off and/or at landing, and at least a second operating configuration of translated flight, in which the aircraft is self-stabilizing; in the first operating configuration said direction of advancement is substantially vertical, while in the second operating configuration the direction of advancement is substantially longitudinal. The transition between the first and the second operating configuration is gradual and allows the aircraft object of the invention to move in such a way as to progressively acquire more and more horizontal speed. During the first operating configuration, the horizontal speed of the aircraft, in particular with respect to the ground, is in fact essentially null.

The structural description of the aircraft 1 will be made with reference to a first reference axis X, which defines the height development of the aircraft 1, to a second reference axis Y, which defines the development thereof in width, and a third reference axis Z, which defines the development thereof in depth and/or defines the direction of advancement of the aircraft, in particular during said translated flight. The axes refer to the structure of the aircraft, and according to the present invention are to be understood as rigidly rotating with the structure of the aircraft itself, so that a mutation of the spatial orientation of the aircraft causes an equivalent mutation of the spatial orientation of the three reference axes X, Y, Z.

### First Embodiment of the Aircraft

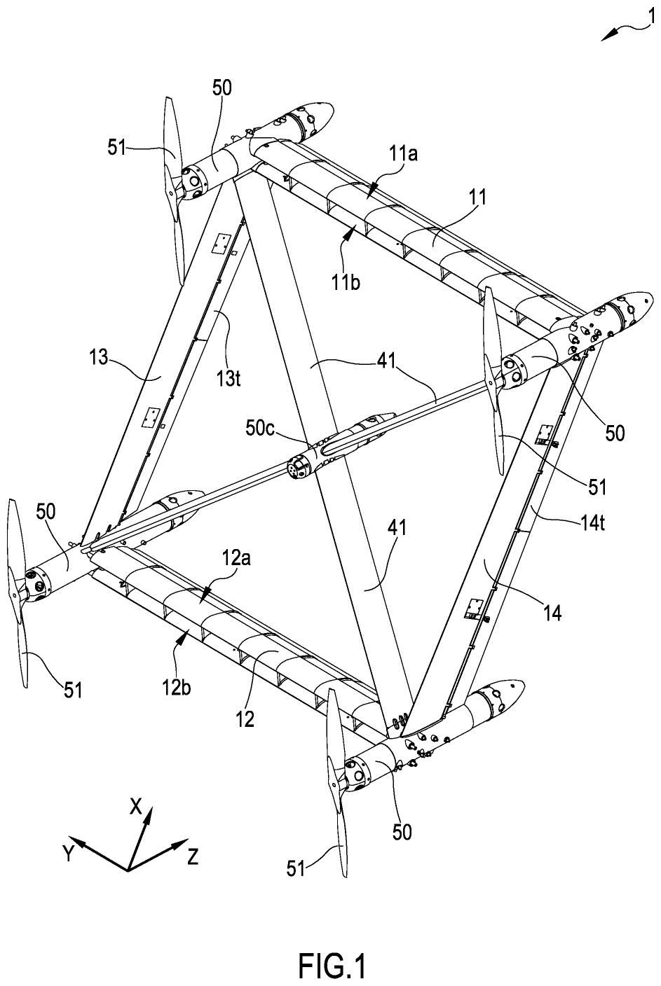

As shown in FIGS. 1-3, the aircraft 1 of the present invention comprises a first wing 11 and a second wing 12 reciprocally superimposed along a direction identified by a first reference axis X and extending for a direction of maximum extension along a direction identified by a second reference axis Y orthogonal with respect to the first reference axis.

The first wing 11 and the second wing 12 are made with a multiple-element configuration comprising a set of wing profiles 21, 22, 23, 24, two or more, which are arranged at least partly in a condition of mutual proximity.

The set of wing profiles comprises at least a first wing profile 21 and a second wing profile 22 which are mutually positioned one after the other and which define a leading edge and a trailing edge, respectively, referring to the direction of advancement of the aircraft 1. In particular, the embodiment illustrated in FIGS. 1 to 3 illustrates a preferred and non-limiting solution in which there are a first wing profile 21, a second wing profile 22 movable with respect to the first, and a third wing profile 23 movable with respect to the first and/or second wing profile. In particular, the mobility of the wing profiles is given by a relative rotation one with respect to the other along an axis parallel to the second reference axis Y.

Interconnection elements or supports 13, 14 are also present, which are designed to hold the first wing 11 and the second wing 12 in a predetermined position. Preferably, although not limitedly, the interconnection elements or supports 13, 14 are installed in proximity of, or substantially at, the first and second ends—mutually opposite—of each of the first and second wings 11, 12. The interconnection supports have an aerodynamic shape, preferably substantially wing, and can contribute to the lift of the aircraft, for example and not limitedly, in the tight turns that the aircraft can perform. The interconnection elements 13, 14 are substantially rigid.

In the embodiment shown in FIGS. 1-3, the interconnection elements 13, 14 are two and comprise a first interconnection support 13, on the left, and a second interconnection support 14, on the right; these interconnection supports may be inclined, and in particular are arranged orthogonally with respect to said first wing 11 and second wing 12. In general, the first interconnection support 13, and the second interconnection support 14, each comprise a first portion which in the embodiment shown in the accompanying figures corresponds to a first end, fixed at a first end of the first wing 11 and at a second end of the first wing 11, respectively, opposite to the first end, and a second portion, which in the embodiment shown in the accompanying figures corresponds to a second end opposite the first end, fixed at a first end of the second wing 12 and at a second end of the second wing 12, respectively, opposite to the first end.

In the first embodiment shown in the accompanying figures, each of the first and second wings 11, 12 comprises a first wing portion 11a, 12a, and a second wing portion 11b, 12b overlapping each other, in particular overlapping each other along a direction substantially identified by the axis X. In particular, such wing portions identify, for each of the wings and as a whole, a first wing plane and a second wing plane overlapping each other. In particular, the overlap occurs along a direction substantially orthogonal to a direction of advancement and/or comprising at least one intrados or an extrados and wherein the overlap occurs along the direction substantially identified by an ideal straight line joining said intrados or extrados of the first wing portion 11a, 12a with the intrados or extrados of the second wing portion 11b, 12b. In order to keep the wing portions separate, the first wing 11 and the second wing 12 each have a plurality of dividing walls, interposed between said first and said second wing and extending along a plane parallel to the first reference axis X and a third reference axis Z orthogonal to both the first reference axis X and the second reference axis Y.

In this configuration, referred to as a double overlapping wing, the lateral bulkiness is drastically minimized with respect to the solutions of the prior art, since a double wing surface is obtained with the same wing extension of the aircraft device. By the preferable configuration with a double wing portion for each of the first wing 11 and the second wing 12, a quadruple wing configuration is obtained, with a further advantage of reduction of lateral bulkiness with the same lift capacity. The configuration of the aircraft object of the invention allows obtaining a minimum induced resistance for the same wing surface and elongation. Moreover, with a reduced lateral bulkiness the maneuverability of the aircraft and its rigidity are also optimized, to which the interconnection supports 13, 14, which in the first embodiment provide a substantially square or rectangle shape to the aircraft, contribute. This particular configuration allows having a particularly robust and resistant structure and a low wingspan with respect to the surface. Also, the particular conformation of the aircraft allows for a very high rate of turn.

The first embodiment of the aircraft object of the invention also comprises a central motor 50c enclosed in an aerodynamic container 40, positioned between the first and second wing 11, 12. The aerodynamic container 40 is fixedly installed with respect to the structure of the aircraft 1, and in particular with respect to the first and second wings 11, 12 and/or with respect to the first and/or second interconnection support 14. This helps to provide additional stiffness and strength to the aircraft itself. The central motor 50c is connected to the first and second wings by a plurality of tie rods or connecting elements 41 each having a first end fixed at a junction point between the first interconnection support 13 or the second interconnection support 14 and the respective portion or end of the first wing 11 or of the second wing 12, respectively, and a second end, opposite to the first end, fixed to said aerodynamic container 40. In the embodiment shown in FIGS. 1-3, the aerodynamic container 40 takes a substantially central and/or substantially barycentric position between the first wing 11, the second wing 12, the first interconnection support 13 and the second interconnection support 14. In particular, said tie rods or connecting elements 41 are crossed with each other, and in particular they form four arms which depart from the aerodynamic container 40. Depending on the ratio between the length of the wings 11, 12 and the length of the first and second interconnection support 13, 14, the angle formed between two arms may be 90° (ratio 1:1 in length) or different.

In a preferred embodiment illustrated in the accompanying figures, the first interconnection support 13 and the second interconnection support 14 integrate movable surfaces, designated by the reference numerals 13t and 14t, which include ailerons or flaps. In a particular non-limiting embodiment, the first and the second interconnection support are arranged in a rear portion of the first and/or second interconnection support 13, 14 and in particular when said first and second support substantially have said wing shape (as in the case of the accompanying figures) they are therefore substantially at the trailing edge of the wing. The movable surfaces may comprise several wing elements or profiles, independently controllable and arranged in sequence one after the other in the direction of advancement of the aircraft, similarly to what happens for the first and second and third wing profiles 21, 22, 23 of the first and second wing. The various wing profiles may act as ailerons or flaps. In particular, the ailerons can rotate relative to the respective first or second interconnection support along an axis parallel to the first reference axis X and allow the execution of yawing, turning and pitching maneuvers for the aircraft 1. This configuration optimizes maneuverability for the aircraft—especially in yaw—even in adverse weather conditions.

Where the first interconnection support and the second interconnection support 13, 14 are provided with more wing elements or profiles, advantageously the execution of very narrow turns is optimized and the aircraft object of the invention can have a greater maximum leading angle prior to stall without relying on too large wing chords that otherwise would compromise the maneuverability of the aircraft, excessively increasing the weight thereof.

Preferably but not limited to, the aerodynamic container 40 integrates all the control, navigation, sensor and telemetry systems necessary and/or useful for controlling the movement of the aircraft. This aspect is convenient since the central position of the aerodynamic container 40 makes these control, navigation, sensor and telemetry systems—all particularly sensitive—less exposed to shocks, for example during the landing of the aircraft and/or during the handling thereof. These systems are also sensitive to magnetic fields and are positioned in a remote position with respect to the peripheral motors that can be installed on the aircraft according to what is described below.

At the ends of the first and second wings 11, 12 there are further motors 50, which preferably comprise an electric machine, in particular an electric motor, whose rotor is fixed to a propeller which is positioned frontally with respect to the wings and the interconnection supports 13, in particular frontally with respect to the leading edge of the first wing 11 and of the second wing 12. The propellers may have a fixed pitch, or alternatively and more preferably, a variable pitch. Moreover, the propellers may be of the foldable type. Moreover, the electric motors may be traditional radial flow electric motors or, alternatively, axial flow electric motors with a rotor coupled frontally with respect to the stator. Alternatively, the motors may be endothermic motors; this solution is conveniently applicable for example if the aircraft object of the invention has considerable dimensions.

The fact of having movable surfaces and in particular the wing profiles behind the propellers of the rotors makes the aircraft significantly more stable in hovering and in case of strong wind and turbulence. Advantageously, the same motors 50 used for vertical flight or hovering in the first operating configuration are also the same propellers that are used for the second operating configuration. These motors 50 are fixedly installed with respect to the first and second wing 11, 12 and with respect to the first and second interconnection support 13, 14 and this ensures greater operating safety, given the absence of complex rotation elements for the motors. Conveniently, the aircraft 1 houses batteries on board, preferably rechargeable, in order to supply electricity to the motors 50. The batteries may be equivalently replaced by fuel cells or propellant tanks.

The first embodiment therefore has 5 fixed motors 50, 50c, of which 4 are peripheral motors installed substantially at the periphery of the first and/or second wing 11, 12. The four peripheral motors, and in particular also the central motor, are installed in such a way as to be oriented parallel to each other in the reciprocal installation positions.

The Applicant has observed that the particular wing profile of the aircraft, in particular with overlapping wing portions 11a, 11b, 12a, 12b, allows optimizing the transition from the first operating configuration to the second operating configuration without risking the stall of the aircraft even if this is characterized by considerable weight.

The box-like structure formed by the assembly of the two parallel wings 11, 12 retained in the periphery by the interconnection supports 13, 14 also allows having a low energy consumption and an optimal aerodynamic efficiency. The box-like structure of the aircraft 1 therefore substantially has sides which are two by two parallel.

The aircraft object of the present invention has a take-off configuration, hereinafter referred to as vertical take-off or first flight attitude, in which the propellers of each of the motors 50 have an axis of rotation inclined with respect to the vertical axis, although preferably close to being vertical; the longitudinal axis of the aircraft is therefore close to being vertical. Due to this configuration it is possible to proceed with the positioning of the aircraft in an upwind direction, and/or in such a way that the axis of rotation of the propellers is facing the direction of origin of the wind. This configuration allows optimizing the take-off capacity of the aircraft in adverse weather conditions and in particular in upwind conditions. Due also to the particular profile of the wings 11, 12 described herein, the aircraft object of the present description has a very high stall angle. Moreover, due to this aspect, the electricity consumption required for take-off is limited. As will be described in greater detail below, following the take-off operating configuration, the aircraft moves towards a subsequent configuration of translated flight.

According to the present invention, therefore, for “upwind” direction reference should be made to the axis passing through the center of the box-like structure and which is parallel to the main direction of advancement of the aircraft according to the shape identified by the wing profile, said axis exiting the aircraft structure towards the direction of advancement.

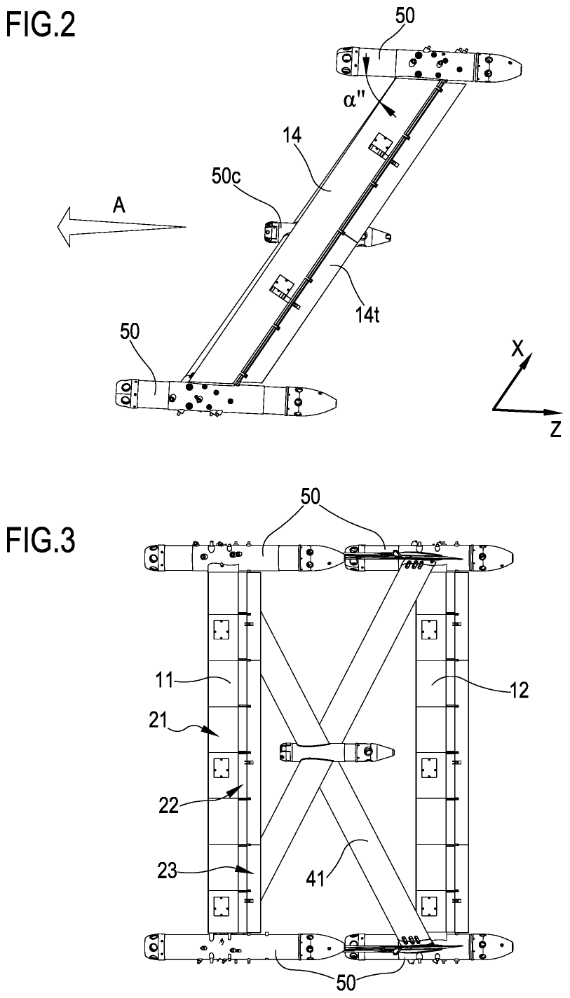

Looking in detail at FIG. 2, it can be seen that the first wing 11 is vertically misaligned with respect to the second wing 12, i.e. it is misaligned in such a manner that even though it remains arranged on a plane parallel or substantially parallel to the plane on which the second wing 12 develops, observing the aircraft 1 from above this is offset horizontally. Having noted that the three reference axes X, Y, Z are orthogonal to each other, as already described, the interconnection supports 13, 14 each develop on a plane parallel to the first and third reference axis X, Z, but the their main direction of development follows a straight line lying on said plane but inclined with respect to the first and third reference axis. In other words, the interconnection supports 13, 14 are connected to the first and second wings 11, 12 according to a shape such that the longitudinal development axis of the interconnection supports 13, 14 forms an angle (a′, a″) with respect to the wing planes of the wings 11, 12. It will be possible to provide two different configurations in which the interconnection supports 13, 14 will be connected to the wings 11, 12:
according to a configuration such that the first wing 11 is positioned frontally with respect to the second wing 12 and with respect to the direction of advancement (indicated by the arrow A) in such a way as to create a certain longitudinal depth which allows obtaining a greater longitudinal stability of the aircraft 1 when it is in flight. In this case, therefore, the interconnection supports 13, 14 are connected to the wings 11, 12 according to a configuration such that the longitudinal extension axis of the interconnection supports 13, 14 form a first angle (a′) with respect to the wing planes of the wings 11, 12, such a first angle (a′) being greater than ninety degrees, preferably comprised between 91 and 135 degrees, even more preferably between 95 and 130 degrees;
according to a configuration such that the first wing 11 is positioned rearwardly with respect to the second wing 12 and with respect to the direction of advancement in such a way as to create a certain longitudinal depth which allows obtaining a greater longitudinal stability of the aircraft 1 when it is in flight. In this case, therefore, the interconnection supports 13, 14 are connected to the wings 11, 12 according to a configuration such that the longitudinal development axis of the interconnection supports forms a second angle (a″) with respect to the wing planes of the wings 11, 12, such a second angle (a″) being smaller than ninety degrees, preferably comprised between 45 and 89 degrees, even more preferably between 50 and 85 degrees. This is the configuration shown in FIG. 2.

In the preferred embodiment illustrated in the accompanying figures, in the direction of advancement, the second wing 12, positioned below, is positioned anteriorly with respect to the first wing 11, and first encounters the air flow.

If the aircraft is provided with a retaining cable 18, as will be better described below, such configurations are particularly important in the event that the retaining cable 18 is broken. In fact the described configuration of the aircraft device 1 allows obtaining good stability conditions and, therefore, in case of breakage of the retaining cable 18, the aircraft 1 is able to be able to land autonomously by gliding within a designated area. In general, the retaining cable 18 is configured to constrain the aircraft to a support on the ground, thereby limiting the movement capacity thereof. The ground support may be fixed or movable, and in a particular embodiment, as described below, it may be a carriage.

Optionally, although preferably, the first wing 11 and/or the second wing 12 and/or the first and/or second interconnection support 13, 14 may comprise a strain gauge, in particular installed on the longitudinal member of the wing itself, so as to being able to feel the wing twist under the effect of the wing lift, i.e. so as to be able to identify whether the wing in question has just been hit by a gust of wind or not. The value detected by the strain gauge is preferably transformed into electronic data transmitted, for example and not limited to, via radio to a remote control system of the aircraft 1, for example introduced into a plant for the production of electricity as will be described in the following portions of the description. The Applicant has observed that the strain gauge value detected by the strain gauge allows identifying earlier and more precisely the possible load variation to which the aircraft 1 of the invention may be subjected during its flight and/or controlling the lift in turning, in particular when the aircraft is fixed to a retaining cable. In particular, the force value detected by the strain gauge allows optimizing the control of the aircraft object of the invention, avoiding the risk of too narrow turns which could lead to the stalling of the lateral wing implemented by the first or second interconnection support.

The particular configuration of the box-like structure of the aircraft object of the invention, integrating the first and the second wing and the first and the second interconnection element, in particular when all provided with movable surfaces, allows starting a roll even particularly accentuated without losing lift.

The generator receives the change in load ahead of the cable and can better smooth out the load peaks.

The aircraft 1 may further comprise a data processing unit, electrically connected with the motors 50 and/or with the central motor 50c, in such a way as to allow rapid control of each of the motors 50, in particular independently of the others. The data processing unit is therefore responsible for controlling the aircraft 1. The values of the strain gauge are also transmitted to the data processing unit, which corrects the flight attitude of the aircraft 1 accordingly, for example by adapting the lift provided by the first wing 11 and/or by the second wing 12, modifying the angle of the movable surfaces so as to smooth the peak load due to the gust. Same thing, but on the contrary, is obtained when the wind decreases in intensity.

Where deemed useful or necessary, the aircraft 1 may also comprise a wireless transceiver module, adapted to transmit and receive flight parameters to and from a remote receiver or transmitter, respectively. Conveniently, the wireless transceiver module is electrically connected to the data processing unit and in use exchanges at least flight data of the aircraft 1 therewith.

The Applicant notes that although in the accompanying figures solutions are shown in which the motors 50 are positioned peripherally, substantially at the corners that are formed between the first wing 11 and the interconnection supports 13, 14 and between these and the second wing 12, thus being wing tip motors 50, further embodiments of the aircraft not shown in the accompanying figures may also be characterized by the presence of a plurality of intermediate motors 50, i.e. installed in intermediate positions of at least the first wing 11 and, preferably, also of the second wing 12; these motors are equally spaced from each other and all installed in a fixed manner with respect to the respective reference wing, so as to increase the flight safety of the aircraft 1. All the propellers installed on the wing preferably retain the features described above and in particular integrate the propeller positioned in front of the leading edge of the wing.

In fact, the Applicant has found that by increasing the number of motors with a driving propeller in front of the wing allows having an accelerated air flow which laps the wing and its movable parts such that even at low speed of the vehicle with respect to the surrounding air (take-off and landing situation), flow speeds are obtained on the wing profile and high movable parts, with greater lift even at low speeds and a more energetic response of the movable parts at low speeds. In particular, the high flow speed that can be obtained on the profile of the first and/or second wing 11, 12 thanks to the front driving propeller (a flow that can be characterized by a speed greater than the speed with which the aircraft moves in space), thus generating lift that occurs on the first wing 11 and/or on the second wing 12.

An accelerated flow on the wings at low vehicle speeds allows the aircraft to rotate from vertical to horizontal in less time, because the lift induced by the flow of the propellers increases the actual lift on the wings and the response of the movable parts to vary the pitch position of the aircraft itself. In this way, the maximum power of the motors, as already seen necessary during hovering and more generally in the first configuration of use, is required for less time, so that also the capacity of the batteries with other conditions being equal may be lower, thus having a lighter aircraft 1. Greater lightness corresponds to a greater contribution of the lift to the dragging on the cable and not to the self-support of the aircraft itself. Moreover, this accelerated flow contributes to allowing an energetic response of the movable parts of the aircraft at low speeds, thus providing both high controllability and reactivity, and also contributes to providing general use safety, in particular at low altitudes, where high turbulence is typically found.

Moreover, a large number of small motors with attached small propellers allows having a lower noise level compared to 4 peripheral motors with propellers with considerably larger diameters. This favors the acceptance by nearby homes, because it reduces noise pollution.

The applicant has in particular observed that the propellers installed on a high number of lower power motors than in the case of 4 motors will have a smaller diameter; in the specific case in which the propellers are foldable, when the propellers are folded back they will have a smaller footprint in being positioned longitudinally and therefore the propeller attachment will be closer to the leading edge of the wings, thus decreasing the total length of the structural parts and one will have an aircraft 1 with a more compact structure.

Moreover, many small motors with their part of attached fuselage with a low frontal impact have a lower impact compared to large motors with large fuselages in terms of aerodynamic resistance, so the total efficiency is improved and therefore the portion of lift that can be used for pulling the retaining cable 18 increases.

In any case, the redundancy of the number of motors allows obtaining a considerable advantage in terms of flight safety, since in the event of any one of a malfunction, breakdown or failure, of one or more motors, at least the maintenance of the flight altitude of the aircraft is guaranteed. This advantage applies both to the solution with 5 motors, 4 of which are peripheral, and to the solution with intermediate motors on the wings.

The independence of the control of the motors 50 can be conveniently exploited both in the solution with 4 or 5 motors as described above, and in the solution discussed herein above, in which each wing 11, 12 has multiple propellers spaced from each other. Some motors 50 may have propellers with a greater pitch to be able to accelerate well from hovering to plane flight like a traditional airplane. Other motors, preferably at low revolutions, will have long-pitch propellers suitable for electrical regeneration during the diving in the passive phase of the cycle that are used to recharge the batteries. In this way, all the motors will help in the various steps, but some will work at maximum efficiency in each of the steps mentioned. The applicant has indicated that in the case where for each wing 11, 12, and optionally for the first or second interconnection support 13, 14, or at least for one of the first or second wing 11, 12 there are motors in an intermediate position, it is also possible to forego variable pitch propellers that would increase the aircraft's construction complexity and related maintenance costs. The flight attitude control, according to the use of intermediate motors installed on the first and/or second wing 11, 12, ensures a more precise control of the aircraft's flight attitude.

In a particular operating configuration, the motors 50, and when the central motor is also present, may operate as an airbrake in order to reduce the speed in gliding and diving, for example during the curve in the “8” path with the cable connected. Preferably, although not limited to, the airbrake action occurs with a rotation of the propellers in a direction concordant with the motion direction of the aircraft, i.e. without rotating the propellers so as to generate an air flow in the reverse direction, in particular opposite, with respect to the flow that locally impinges the motors. In a particular configuration, the motors 50 are configured in such a way as to be actuated independently of each other, thus exerting an airbrake control and therefore of independent deceleration, variable from each other and/or variable over time. Independence in the operating configuration of airbrake is preferably managed through the control unit. This allows generating torques such as to cause the aircraft to rotate on itself, thereby controlling its trajectory. Through the airbrake action, and since said motors 50 are electric, it is possible to recharge batteries.

Preferably, but not limited to, at least part of the body of the aircraft object of the invention is made of a material visible to the infrared and/or visible for wavelengths greater than 600 nm, more preferably 700 nm. Alternatively, part of the body of the aircraft may be lined with materials having the aforementioned infrared visibility properties, for example by means of infrared radiation reflecting layers emitted by illuminators and made in the form of paint or adhesive element. In a particular embodiment, especially the retaining cable 18 has infrared visibility properties. Advantageously, this contributes to avoiding the risk that traditional aircraft inadvertently impact against the aircraft object of the invention due to its poor visibility at night, since the aircraft of the invention, thus equipped, can be easily observed by and/or through night viewers which for example, pilots of fixed-wing or mobile-wing aircraft use during night flights, including those for search and rescue. Such viewers typically exhibit maximum sensitivity in the neighborhood of between 600 nm and 900 nm. The use of materials with infrared visibility properties, moreover, contributes to safeguarding the electricity on board. In fact, the visibility of the aircraft so equipped is not given by properties of active lighting, but by a peculiarity of passive visibility that does not need or use energy resources on board.

### Second Embodiment of the Aircraft

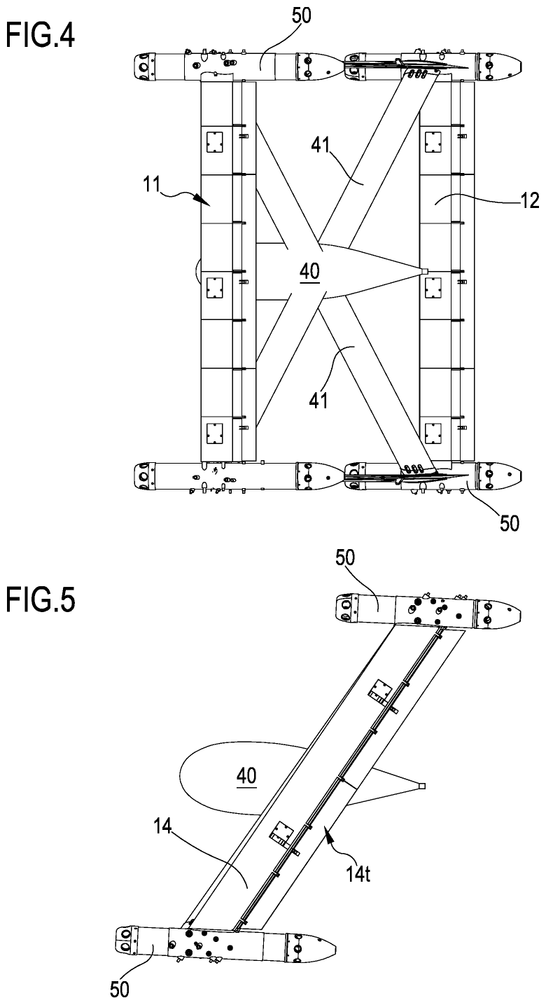

A second embodiment of the aircraft according to the invention is illustrated in FIGS. 4 and 5; this second embodiment has substantially the same features as the first embodiment, to which the reader should refer for reading. It should be noted that the features described above also as optional for the first embodiment of the aircraft 1, can be applied to the second embodiment described herein. In particular, this second embodiment is optimized to make a cargo drone.

In particular, this embodiment is characterized with respect to the first embodiment in that the aerodynamic container 40 contains an internal volume adapted to carry loads. The second embodiment is therefore that of an unmanned aircraft 1 with four peripheral fixed motors. In particular, the Applicant has found that the use of an aerodynamic container 40 fixed with respect to the structure of the aircraft, with the particular fixing configuration with respect to wings and interconnection supports as described above, allows avoiding dangerous tilting of the load which risks compromising the stability of the flight. Thus, compared to other positions, an aerodynamic container 40 fixed in the position described above in relation to the structure of the aircraft 1 according to the present description allows supporting very high masses with significantly lower flight stability.

The Applicant has observed that, when the aerodynamic container is positioned in the substantially barycentric position described above, the load will also be in this position; for this reason, the optimization of the transport of the load is achieved. Although the accompanying figures do not illustrate it, the second embodiment may have further aerodynamic containers in the vicinity of the first or second wing and/or in the vicinity of the first or second interconnection support 13, 14, to provide additional space for transporting loads.

Optionally, both the first embodiment and the second embodiment of the aircraft according to the invention may comprise a plurality of aerodynamic containers 40, in addition to the one described above, each of which is configured to accommodate loads contained in a space or recess or cavities made therein. Such aerodynamic containers, according to a preferred embodiment, are arranged so as to identify a main direction of development which extends parallel to the direction of advancement which the aircraft 1 assumes in flight, and therefore parallel to a third reference axis Z. These aerodynamic containers are always fixed.

Both the first and the second embodiment of the aircraft 1 of the invention may be used to make a drone retained by a cable. In particular, the drone may be retained with a retaining cable 18 towards a carriage 8 slidable on a guide, in order for example to allow—through the carriage 8—a generation of electricity. Such a carriage 8 will conveniently be designed to integrate means for producing electricity. The aircraft 1 of the invention may be applied to ring wind turbine plants 10, with a cable system that carries the aircraft 1 at high altitude, where there is a high air flow both in terms of intensity and availability over time. In fact, studies carried out in the field of wind energy production show that wind speed and its uniformity increase with increasing altitude. For example, at a height of 100 m from the ground the average wind values have poorly exploitable characteristics due to their low intensity or low constancy, while at 400 m above the ground the wind speed is always exploitable for electricity production purposes and has characteristics of greater constancy over time. Since the wind power is proportional to the triple power of the speed, the efficiency of a plant that uses an aircraft 1 like the one object of the invention at high altitude has better performances compared to low-altitude wind turbine systems, obtaining a greater yield on equal ground occupied area. In fact, by comparing different types of plants, a wind turbine plant located in the hinterland has an average production capacity of 700 W/square meter, a wind turbine plant on the coast has an average production capacity of 1000 W/square meter, while the plant described herein is able to obtain production capacities higher than 1800 W/square meter.

### Plant and System for the Production of Electricity by Aircraft

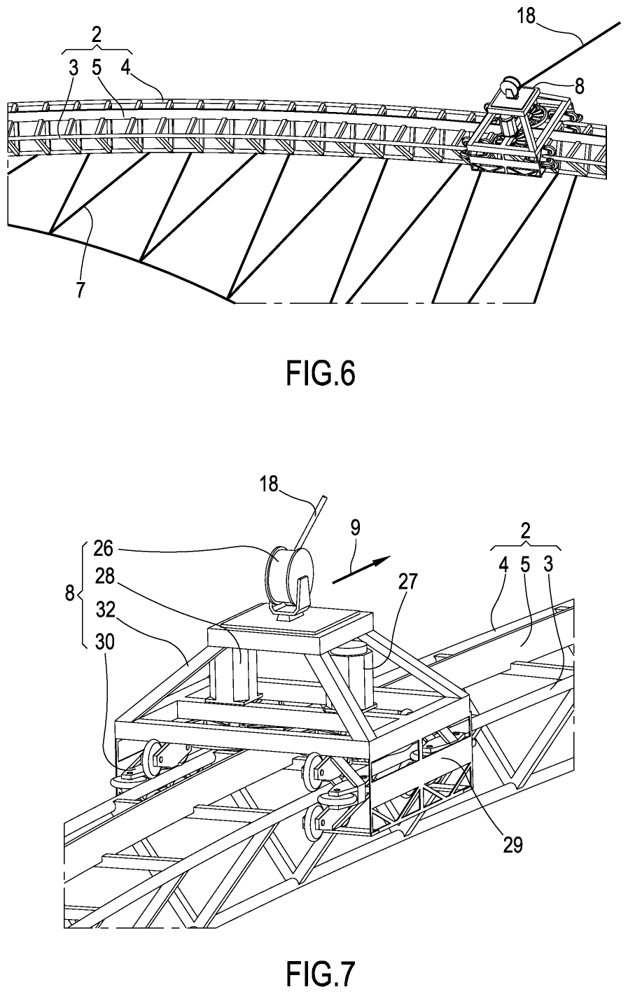

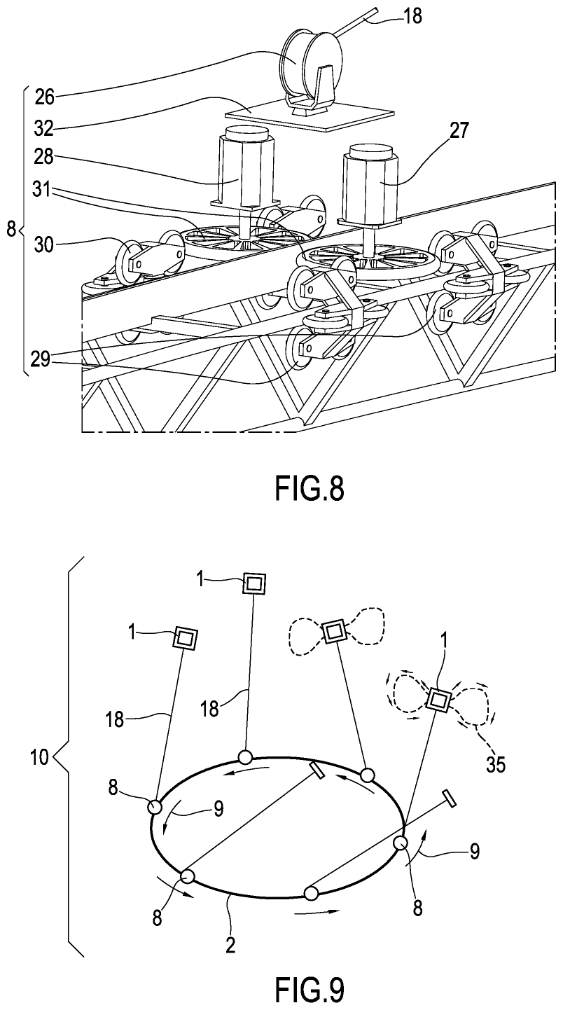

The aircraft 1 object of the invention is able to be connected to a ground structure which implements an electricity production plant or system, described herein in a first and non-limiting embodiment, which as shown in FIGS. 6-9 comprises a closed circuit, preferably but not necessarily with an annular conformation, which comprises a guide 2 along which one or more carriages 8 are slidingly connected, each of which is towed, by means of the retaining cable 18, by a corresponding aircraft 1 that in use is made to take off in a controlled manner in order to be placed at a height. Consequently, on the guide 2 multiple carriages may be present traveling on the guide 2 in an equidistant manner from each other, each towed by a respective aircraft 1. The at least one carriage 8 is therefore subject to a pulling force by the aircraft 1, which is propelled by the wind, and the exercise of said pulling force occurs by means of the retaining cable 18.

The guide 2 is supported in a raised position with respect to the ground by means of a series of pylons 6, preferably placed in a position that is mutually equidistant along the longitudinal development of the guide 2 itself. The structure consisting of guide 2 and pylons 6 is anchored to the ground by a system of fixing ropes 7 and such a system imparts a high resistance to lateral loads.

The guide 2 comprises a first rail 3 and a second rail 4 mutually parallel and spaced which are preferably made in the form of tubular rails. The first rail 3 and the second rail 4 act as guide means for holding the carriage 8 in position. Furthermore, the guide 2 also comprises a track 5 which is preferably arranged between the first rail 3 and the second rail 4. The central track serves to discharge the dragging forces of the aircraft device 1 and to activate transmission wheels 31 of the carriage 8 which are opposite rubber wheels which are in contact on opposite sides of the central track 5.

The carriage 8 is provided with a frame 32 to which are fixed:
a first group of retaining wheels 29 which are slidably engaged on the first rail 3;
a second group of retaining wheels 30 which are slidably engaged on the second rail 4;
a pair of opposite transmission wheels 31 which are in contact on the opposite sides of central track 5.

Each group of retaining wheels 29, 30 may comprise a set of front wheels and a set of rear wheels, in which the terms “front” and “rear” refer to the advancement direction 9 of the carriage 8 on the guide 2. Each set of wheels may be made by means of three pairs of wheels which are slidably engaged on the respective rail 3, 4 according to different engagement directions, for example according to engagement directions arranged at ninety degrees with respect to each other. The groups of retaining wheels 29, 30 serve to hold the carriage in position with respect to the respective rail 3, 4.

On each carriage 8, a winch 26 is installed to unwind and wind the retaining cable 18 of the aircraft during take-off and landing. The winch 26 comprises its own motor connected to a coil for winding and/or unwinding the retaining cable 18. The winch further comprises a control system and a power supply system connected to the power supply network and provided with an emergency battery to be able to manage the winding and/or unwinding of the retaining cable 18 in the absence of mains power.

The carriage is also provided with at least one motor—generator, possibly two motors or generators 27, 28. The motor—generator or the motors—generators 27, 28 implement means that convert the kinetic energy of the carriage 8 into electrical energy. For example for a solution with two motors—generators 27, 28, a first motor—generator 27 is connected to a first of the transmission wheels 31 and a second motor—generator 28 is connected to a second of the transmission wheels 31 which are two solid counter-rotating rubber wheels in contrast on the central rail 5 of the guide 2 so as to unload the whole load without the risk of slipping.

The aircraft flies at high speed parallel to the ground moving alternately to the right and to the left with respect to the guide 2, performing an essentially 8-shaped and/or circular trajectory and/or on a curved trajectory according to, for example and not limited to, the wind direction.

Each aircraft 1 may be controlled by means of a control system comprising one or more of position sensors, acceleration sensors, GPS positioning sensors, sensors controlling the direction of the retaining cable 18, radar position sensors. In this way, one is sure of the position of each aircraft 1 present on the guide 2 and the risk of collision both between the aircraft devices 1 themselves and between the aircraft devices 1 and external aircraft is eliminated or drastically reduced. The aircraft 1 is controlled by means of servo-controls positioned on the aircraft device 1 itself so as to make it follow a path with an 8-shaped and/or circular trajectory or on a curved path, according to what described hereinafter in the present description.

In order to reduce the aerodynamic resistance thereof, a profiled foam rubber lining is attached around the retaining cable 18 to reduce aerodynamic resistance. At regular intervals, a piezoelectric generator is inserted along the lining which is charged with the vibrations generated by the aircraft 1 during the flight. The piezoelectric generator will supply a series of luminous devices, preferably LED, which allow the detection of the retaining cable 18 at night. The lining 41 will preferably be further provided with reflecting parts so as to increase visibility even during the day. The fact that the lining 41 has a greater dimension than the retaining cable 18 also contributes to increasing the visibility thereof during the day.

The retaining cable 18 has a less resistant point at the area of attachment with the aircraft 1 in such a way as to achieve a preferential breaking point. Since the breaking point is positioned at the area of attachment with the aircraft 1, in case of breakage, the retaining cable 18 can be quickly rewound by the winch 26 without risking to cause damage by falling of the cable in the case in which it reaches the ground far from the plant 10 while it is dragged by the aircraft 1 in emergency maneuver. The retaining cable 18 is therefore removably connected to the aircraft of the invention. Optionally, although preferably, the aircraft 1 may be provided with a remote controlled system or device for the controlled release of the retaining cable 18.

The Applicant has observed that the aircraft 1 is often found to operate in areas that may present static electricity and/or may be subject to lightning. For this reason, again optionally though preferably, the retaining cable 18 is made of electrically insulating material, in order to avoid the propagation of lightning to the ground.

In a particular embodiment, the retaining cable 18 may be provided and/or formed by at least one and more preferably a plurality of bridles which are connected at distinct points of the aircraft, in particular at the junction points between the first wing 11 or the second wing 12 with the respective interconnection elements 13, 14 and/or at the ends of the first wing 11 and/or second wing 12, and/or first and/or second interconnection element 13, 14. The bridles are therefore, preferably although not limited to, 2 or 4. The use of the aforementioned bridles allows greater control of the aircraft during the turns and advantageously allows optimizing the positioning of the aircraft so that it is always facing the wind. In particular, the aircraft 1 of the invention, when provided with the aforementioned bridles, has limited rolling or pitching capability, and the turns can be performed substantially, more particularly only, by yaw, in particular when the cable is kept taut. The use of bridles also allows distributing the wing load on multiple points. The least resistant point of the retaining cable 18 is preferably placed at the junction of the end of the retaining cable with the bridles.

### Rotating Support Base for an Aircraft

Another object of the present invention is also a base 100 for an aircraft, in particular for an aircraft according to the present invention. The base 100 constitutes a part of an electricity generation system, in a second alternative and preferred embodiment with respect to that mentioned above, specifically configured to operate with the aircraft object of the invention.

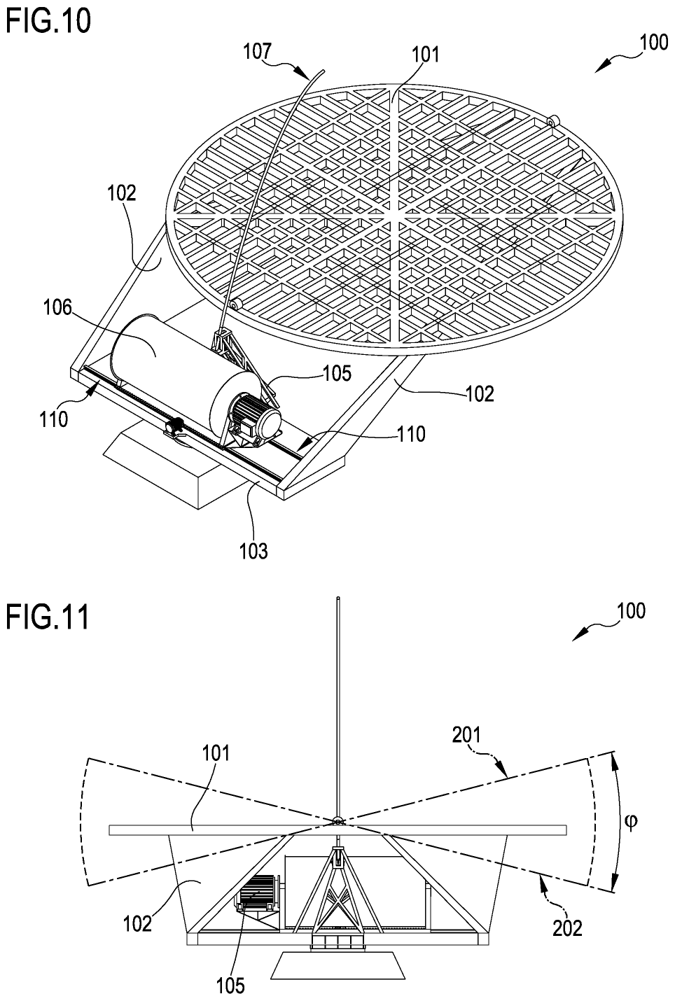

As illustrated in FIGS. 10 and 11, the base 100, which in use is installed in a predetermined and fixed position on the ground, comprises first of all a support platform 101 for the aircraft; the platform 101 has a substantially circular area even if such a shape is not intended to be limiting. The platform 101 has a size such as to be able to accommodate at least part and preferably the whole aircraft 1. In the embodiment shown in the accompanying figures, the platform is implemented by a grid, which advantageously allows the discharge of the water if used in the rain, and which in any case allows reducing the overall weight of the object.

The platform 101 is supported by a support comprising two lateral supports 102 and a base 103; each of the lateral supports 102 has a first end connected to the platform 101 and a second end fixed to the base 103. The base 103 is made with a preferably elongated shape and integrates a drum 106 for a cable, in particular for the retaining cable 18, and a motor 105, preferably but not limited to electric, comprising a rotor rigidly constrained to the drum 106 so as to be able to adjust and/or control the rotation in a clockwise or anti-clockwise direction and consequently adjust the unwinding or rewinding of the retaining cable 18. The rewinding can take place preferably immediately following the lowering of the aircraft height, so as to avoid leaving the retaining cable excessively floating.

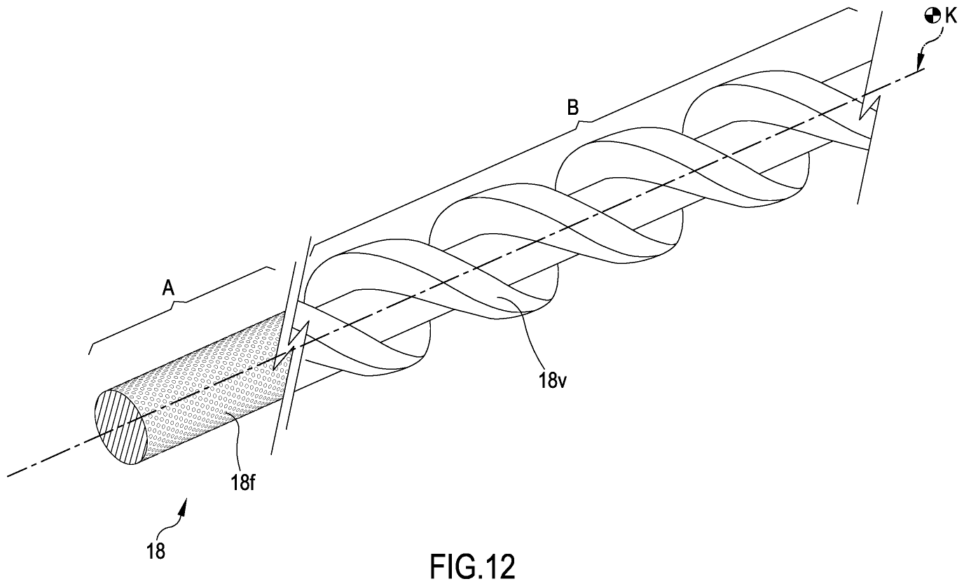

While the retaining cable 18 may be a traditional circular section cable, for example and not limited to a plastic and/or plastic fiber type, the Applicant has noted that the retaining cable 18 may conveniently be a cable with low aerodynamic resistance and comprising, as in the case of the portion A of FIG. 12, a rough surface 18f, for example provided with a plurality of concavities or recesses arranged around the lateral surface of the cable, and a Reynolds number preferably comprised between 10⁴ and 10⁵, such that the aerodynamic resistance drops to Cd values lower than or equal to 0.7, more preferably lower than 0.6 and even more preferably lower than 0.5. The rough surface of the cable helps to maintain a turbulent flow around the cable itself, which helps to reduce downforce. The use of a rough surface also helps to reduce the vibrations of the cable, particularly when it is unwound by a significant length. The cable section may have a section shaped as Savonius turbine or helical 18v as in the case of the portion B of FIG. 12, thus developing on at least part of the cable portion which extends in the axial direction, on the axis of the cable indicated by the letter K. Such a Savonius turbine or helical section may possibly be combined with a low aerodynamic resistance surface.

Moreover, the retaining cable 18 may have a rotating portion, in particular the portion which is not wound in the drum, i.e. the one closest to the aircraft. The rotating portion is joined with the rest of the cable by means of a rotating axial junction element, for example idle as a thrust bearing, and may optionally be assisted by an active rotation system. The rotating portion of the cable may be rotating by passive rotation given by the Savonius effect surface or by active rotation generated by an electric motor placed on the aircraft and which uses the batteries possibly present on the aircraft itself.

The Magnus effect of the cable generates a reduction in the aerodynamic resistance and a lift that depending on the direction of spin can help lift the aircraft with respect to the horizon, so it is possible to have a cable angle lower than the horizon, since less lift is required to support the weight of the aircraft and cable A smaller cable angle leads to greater wind usage and greater power generation efficiency.

Given that during flight with an 8-shaped trajectory, in a motion direction, the cable would aid the support but, in the opposite direction, the weight of the system would increase, it is possible to introduce a thrust bearing at the end of the cable connected to the aircraft, on the connection with the bridles; in this way it is advantageously possible to quickly invert the direction of rotation of the retaining cable 18, with a contrasting effect on the winding. In other words, by reversing the rotation of the cable with each reversal of motion during the 8-shaped trajectory performed by the aircraft, the lift generated helps the cable to sustain itself.

Preferably, the platform 101 is rotatably installed with respect to the base 103, in particular in such a way as to be able to rotate relatively around an axis which extends in a substantially vertical direction. Preferably, the platform 101 is idly installed with respect to the base 103. In this case, each of the lateral supports 102 has a substantially aerodynamic shape, with surfaces extending along a plane comprising this axis which extends in a substantially vertical direction. In other words, each of the lateral supports 102 has a substantially vertically oriented wing shape, which in use, under the effect of the wind, makes it possible to align the platform 101, by rotation relative to the base 103, with the wind direction. The base described herein therefore provides a passive wind search system, in particular of the upwind direction, and/or is configured to passively search for the wind direction and position itself in an upwind direction with respect to the latter. The lateral supports 102 are inclined in the opposite manner, so as to ensure that if the wind changes direction the more exposed lateral support has a wider rotation torque than the other.

In a preferred and non-limiting embodiment of the invention, the drum 106 and/or the motor 105 are mounted on a pair of guides 110, installed on the base 103, which allow the axial sliding of the drum-motor assembly with respect to the base 103.

A peculiar feature of the base 100 object of the invention is that whereby the platform 101 is movable with respect to the base 103, and can be in particular movable by rotation with respect to a zenith axis of the base 103—such zenith axis substantially coinciding, in use, with the vertical axis—and/or it may be inclined with respect to said base 103.

The constraint of the lateral supports 102 with the platform 101 may not be rigid but allow a pivoting of the platform with respect to a horizontal central and neutral position; the platform is therefore designed to rotate with respect to a central rotation point, so as to have at least one side positionable, due to the rotation, between a maximum height of 201 and a minimum height of 202, making a rotation angle φ.

The base 100 may also comprise a dome-shaped closure element, having at least a first open configuration and a second closed configuration, in which in said first open configuration the closure element leaves the aircraft 1 free to be able to take off or land on the platform 101, while in the closed position the closure element allows complete coverage of the aircraft 1, sheltering it from the elements.

In a preferred and non-limiting embodiment, the base 100 comprises a battery charger for the aircraft 1, in particular a battery charger of the non-contact type. Thanks to this aspect, when the aircraft 1 is on the 101 platform, one has the guarantee of an immediate recharge of the batteries installed therein, so that on the next flight, the batteries are as charged as possible.

In a preferred and non-limiting embodiment of the invention, the base 100 integrates a disconnectable supply system for the aircraft 1. Such a disconnectable supply system was conceived on the basis of the fact that the Applicant has noticed that during the take-off step and in the early stages of flight the aircraft 1 consumes a significant amount of energy.

There is therefore a cable, optionally the retaining cable 18, comprising an electrically conductive conductor, suitably shielded, acting as an at least temporary supply means for the aircraft 1. In use, during the first operating configuration, the aircraft 1 is fed through the cable, and the battery installed on board is not used to supply electrical current useful to the motors 50, 50c; otherwise, upon reaching a predetermined altitude which may also be the transition altitude between the first and second operating configurations, the power supply cable is disconnected from the aircraft 1 and this can be made independently powered by means of its own batteries. Conveniently, in order to hold the power cable in the correct position above all during the initial steps of the flight and/or take-off of the aircraft 1, the base 100 may be provided with a telescopic tube 107 which from the base 103 extends at least partially above the platform 101 in a preferably oblique direction with respect to the latter. The telescopic tube, which more generally takes the form of a tubular element on which, within which or with respect to which the retaining cable 18 of the aircraft can slide, has a free end and an end, opposite to the free end, fixed to the base 103. In particular, the tubular element is made and/or configured to be a voltage damper on the retaining cable 18, and is in particular configured to dampen the voltage generated on the retaining cable 18 when the aircraft 10 is subject to sudden gusts of wind.

The base 100 described herein may be controlled electronically in its spatial orientation, in particular by means of a servo actuator electrically connected to a data processing unit which has an input, physical or logical, supplied with a signal coming from a wind sensor, in particular at least one sensor adapted to identify the direction of origin of the wind. This data processing unit is configured so as to position, by rotation and/or inclination, in particular the platform 101 so that it lies inclined and/or directed against the wind. Thanks to this aspect and to the particular structural configuration, the take-off of the aircraft 1 in adverse wind conditions is facilitated, and the energy consumption of the aircraft 1 is considerably reduced.

A particular non-limiting embodiment of the base 100 according to the invention is characterized by the presence of an inertial measurement unit (IMU), positioned at or substantially at the telescopic tube 107. In particular, although not limitedly, the inertial measurement unit is positioned at one end, in particular the free end, of the telescopic tube 107. The inertial measurement unit may be combined with a strain gauge or a load cell adapted to detect the load and/or the force with which the retaining cable 18 is pulled or held.

The inertial measurement unit is configured to detect, by means of suitable sensor means, sudden loads on the telescopic tube 107, and in particular of sudden bending loads on the telescopic tube 107. The applicant has in fact observed that sudden bending loads on the telescopic tube can indicate a sudden gust of wind. Such loads can be in particular such as to cause an early wear of the retaining cable 18. In particular, if the telescopic tube 107 takes a bent shape, the prompt detection of sudden loads on the free end of the telescopic tube 107 allows the adoption of appropriate measures for the reduction of the immediate strain on the winch, such as for example the progressive and controlled release of part of the retaining cable 18, unwinding part thereof from the same winch. This control is advantageously performed by an automatic algorithm executed by the data processing unit.

Through the base of the present invention electricity is generated by means of a yo-yo effect with the aircraft described above. In particular, the electricity is produced through the unwinding and rewinding of the retaining cable 18 on the drum. The unwinding of the cable takes place by dragging the aircraft when exposed to the wind. Through the “8” trajectory described above, a lift is generated and therefore a dragging on the retaining cable 18, which, with a generator mechanically connected to the drum on which the retaining cable 18 is partially wound, generates electricity.

### Description of the Control Method of the Unmanned Aircraft of the Invention

The aircraft 1 is actuated according to a process which is described below. First of all, the aircraft is positioned on a platform, in particular on the platform 101 described above, and then at least one motor 50 is activated among the plurality of motors 50 of the aircraft, preferably more motors and even more preferably all four peripheral motors.

Starting from a first operating configuration of vertical take-off or first flight attitude, through a step of adjusting the power generated by said plurality of motors 50 a variation of said first flight attitude is carried out in a further flight attitude identifying a second operating configuration of the aircraft 1 in which it proceeds in translated flight with a horizontal translation component; the step of adjusting the power generated by said plurality of motors 50 causes an alteration of the spatial orientation of the structure of the aircraft 1 and conveniently, although not limitedly, it can be performed automatically by means of an algorithm which is automatically executed by the data processing unit.

Advantageously, the alteration of the spatial orientation of the structure of said aircraft 1 and/or the variation between the first and the second arrangement takes place by means of motors 50 rigidly joined to the structure of the said aircraft 1, and this allows optimizing the safety of the aircraft and to contain the dimensions thereof with respect to aircraft that use orientable motors or in any case permanently installed but differentiated by orientation and by operating function.

According to a further non-limiting aspect, said method comprises a step of performing a turn and/or pitch and/or roll by the actuation of movable surfaces 13t, 14t of at least one interconnection support 13; 14 and/or of the movable surfaces of the first and second wing 11, 12, adapted to describe the “8” and/or circular and/or curved trajectory.

Where present, the variable pitch propeller for the motors 50 of the first and second embodiments of the aircraft 1 object of the invention can be used in the control procedure of the aircraft which is described below.

The variable pitch propellers allow to have an excellent hovering preferring the low pitch and optimizing the take-off and landing precision without heating the motors and regulators. A medium pitch to accelerate the translated flight and a high pitch to optimize the torque generation during the use of propellers as wind micro-turbines to recharge the batteries on board the aircraft itself. In particular, the applicant emphasizes the importance of optimizing the pitch of the propellers according to the load that the vehicle 1 bears; this aspect is particularly important for the second embodiment of the aircraft 1.

For the first embodiment as well as for the second embodiment, the control method of the aircraft therefore provides a step for controlling the pitch of the propellers according to the operating configuration of the aircraft, in which the control step provides an increase in the step of at least one of the motors in the transition from the first operating configuration to the second operating configuration. In particular, the control method of the aircraft provides for having a minimum pitch for said propellers during the take-off and/or landing steps of the aircraft itself.

In flight, the method provides a remote and/or automatic control step of the aircraft 1 by varying and/or adjusting the power supplied by each of the motors 50, 50c according to the specific flight conditions, and in particular comprises a step of adjusting said power in order to cause said aircraft to perform controlled turns to describe an “8” trajectory, in particular during an active electricity generation step.

Moreover, the method provides a verification step, preferably electronic and/or automatic, of the lift that at least the first wing 11 and the second wing 12 exert on the aircraft 1, and, if such lift is sufficient to keep the aircraft 1 in flight without the aid of the power supplied by the motors 50, 50c, the method comprises a step of positioning the propellers so as to have zero and/or flag angle of incidence.

The control method of the aircraft may also comprise a step of controlling the descent and/or landing of the aircraft 1, wherein in said step of controlling said descent, if preferably by an electronic and/or automatic control of the lift it is detected that at least the first wing 11 and the second wing 12 generate sufficient lift, the propellers of the motors 50, 50c are positioned so as to use these motors 50, 50c as electricity generators. Thanks to this aspect it is advantageously possible to use the motors to at least partially recharge the batteries of the aircraft 1 during the descent, helping to increase the operating autonomy thereof.

During the take-off step, in the first operating configuration, therefore, the motors are activated, in particular they are all activated, to cause the aircraft to be lifted off the ground. This lifting preferably but not limitedly takes place in a vertical or substantially vertical direction. However, the Applicant has observed that it is possible to optimize the take-off of the aircraft 1 in the configurations described in the first and second embodiments even in the case of strong wind. Taking advantage of the lift provided by the first and second wings 11, 12 shortly after detachment from the ground, although it can move in a substantially vertical direction, i.e. orthogonal to the ground, the aircraft 1 of the invention begins to vary its spatial orientation towards the orientation that it would assume in the second operating configuration.

Preferably, but not limited to, through the revolving property of the previously described base 100, take-off takes place upwind, so as to favor the immediate lift that the aircraft takes when its operating configuration or spatial orientation changes towards the configuration in which it moves with translated flight. Therefore, a step for moving the platform 101 of the base 100 is provided in such a way as to place the aircraft supported thereon in the upwind direction.

Following the take-off step, the control method of the aircraft includes a control step of the motors 50 in order to cause a rapid transition from hovering flight to a translated flight.

Where the aircraft is used in the system for producing electricity according to the invention, the method comprises a step of progressive release of the retaining cable 18, by means of a partial unwinding of the latter from the drum, alternated with and/or followed by a step of at least partial rewinding of the retaining cable 18 on the drum, wherein at least during the partial unwinding a generator connected to the drum on which the retaining cable is wound causes the production of electricity. In particular, the at least partial unwinding step is passive, and is caused by the pulling action that the aircraft 1 exerts on the retaining cable 18 due to the wind.

The control method of the aircraft can also contemplate a control and damping of the load peaks produced by the gusts of wind and/or the maintenance of a constant lift; this control in particular comprises measuring the load and/or bearing capacity on the first wing 11 and/or second wing 12 and/or the first interconnection element 13 and/or second interconnection element 14, preferably but not limited to through the strain gauge described above. In particular, the method, following said load and/or lift measurement, comprises a correction, preferably automatic, of the movable surfaces of said first wing 11 and/or second wing 12 and/or first interconnection element 13 and/or second interconnection element 14, in particular a control aimed at increasing the incidence on the lift made by said movable surfaces if the load and/or lift measurement decreases with respect to a predetermined value, and a decrease in the incidence on the lift made by said movable surfaces if the load and/or lift measurement increases with respect to the aforementioned predetermined value.

The advantages of the invention are apparent in light of the foregoing. The system for producing electricity through the aircraft object of the invention and the base object of the invention combines the advantages of traditional yo-yo systems and movable carriage systems, mitigating the drawbacks thereof. Even with a significantly greater compactness, the system with the base 100 allows the aircraft to take off even in the absence of wind on the ground, as would a carousel system. The production of electricity is substantially continuous. The particular movement of the aircraft allows reducing the resistance of shape, wake and noise of the retaining cable and therefore considerably increasing the power extracted from the wind.

With regard specifically to the aircraft, the four-wing structure, two of which are substantially implemented by the interconnection elements 13 and 14, allows for the optimization of lift even in the case of sharp turning maneuvers, allowing the optimal lift to be maintained even during the yaw.

The present invention lends itself to numerous variants that can be carried out by a man skilled in the art, all falling within the scope of protection defined by the following claims.

1. Unmanned aircraft, comprising a first wing (11) and a second wing (12), wherein at least one of the first and second wings (11, 12) are made with a multiple element configuration comprising a set of wing profiles (21, 22, 23, 24) which are arranged at least partially in a condition of mutual proximity, said set of wing profiles comprising at least a first wing profile (21) and a second wing profile (22) which are mutually positioned one after the other and which define a leading edge and a trailing edge, respectively, wherein said first wing (11) and said second wing (12) are spaced with respect to each other; said aircraft further comprising interconnection supports (13, 14) between said first wing (11) and said second wing (12), holding said first and second wing (11, 12) at a given distance,
said unmanned aircraft further comprising at least one aerodynamic container (40) positioned between said first wing (11) and said second wing (12), said aerodynamic container (40) comprising an inner compartment and a casing enclosing said inner compartment and being adapted and configured to carry a load and/or a central motor (50c).

2. Unmanned aircraft according to claim 1, comprising a plurality of motors (50), optionally a plurality of electric machines having a rotor axially fixed to a propeller (51) and/or wherein in correspondence of said first wing (11) and said second wing (12) a plurality of electric machines are present, comprising a rotor axially fixed to a propeller (51), wherein said propeller (51) is a driving propeller configured to produce, in at least a predefined condition of use, an accelerated air flow that touches and/or impinges the profile of said first wing (11) and/or said second wing (12), optionally causing, substantially at said at least one first wing (11) and/or said second wing (12), an air flow of greater speed than the speed at which said aircraft moves, and/or configured to generate a lift on said first wing (11) and/or second wing (12).

3. Unmanned aircraft according to claim 2, comprising an operating configuration in which at least part of said plurality of motors (50) is configured to exert an action, or airbrake, optionally by means of a braking action caused by a rotation of the propellers concordant with the motion direction of the aircraft, optionally wherein, in said operating configuration, said motors (50) are controlled independently so as to each generate a variable braking force, and said aircraft is configured to perform in use a trajectory along a curve at least partially, optionally completely, followed through the variable braking action of said motors (50).

4. Unmanned aircraft according to one or more of the preceding claims, comprising a retaining cable (18), wherein:
said retaining cable (18) is a cable with low aerodynamic resistance and/or provided, for at least a portion thereof, with a lateral surface at least partially, more preferably integrally, covered with concavities or recesses adapted to favor the reduction of the aerodynamic resistance of the cable itself and/or is provided with at least a portion comprising a helical surface and/or a Savonius turbine-shaped surface; and/or wherein
said retaining cable (18) is a cable at least partially rotating with respect to its own development axis (K), and in particular said portion having said helical surface and/or Savonius turbine-shaped surface is rotating; and/or wherein
said retaining cable (18) is retained, at a portion thereof, in particular end, with a rotating bearing.

5. Unmanned aircraft according to claim 4, comprising a motor adapted to rotate at least part of said retaining cable (18), wherein—optionally—said motor comprises at least a portion fixed in correspondence of and/or on said retaining cable (18).

6. Unmanned aircraft according to one or more of the preceding claims, wherein at least part of said aircraft is coated with and/or made of a material that is visible to the infrared and/or reflecting the infrared and/or visible for or reflecting wavelengths greater than 600 nm, more preferably 700 nm and/or is characterized by night visibility, and wherein in particular the retaining cable (18) has infrared visibility and/or infrared reflection properties and/or visibility or reflection of wavelengths greater than 600 nm, more preferably 700 nm and/or is characterized by night visibility.

7. Unmanned aircraft according to one or more of the preceding claims, comprising a first operating, take-off and/or landing configuration, and a second operating configuration of translated flight, wherein in said first operating configuration, the propellers (51) of each of the motors (50) have an axis of rotation inclined with respect to the vertical axis, although close to being vertical and/or the longitudinal axis of said aircraft is close to being vertical, said aircraft being configured to take off against the wind and/or the first operating configuration is an operating configuration of windward take-off and/or landing, wherein the axis of rotation of the propellers is facing the direction of origin of the wind.

8. Unmanned aircraft according to one or more of the preceding claims when dependent on claim 4, comprising a plurality of bridles, optionally 2 or 4 bridles, wherein said bridles are installed at end portions of said first wing (11) and of said second wing (12); said plurality of bridles being removably connected to said retaining cable (18).

9. Aircraft according to one or more of the preceding claims, wherein the interconnection supports (13, 14) comprise a first and a second interconnection support (13, 14), and wherein said first interconnection support and/or said second interconnection support (13; 14) are rigid supports, optionally substantially wing shaped, and integrate movable surfaces (13t, 14t) comprising ailerons or rudders or flaps and/or wherein said first or second wing (11, 12) integrate movable surfaces, wherein said movable surfaces (13t; 14t) are configured to modify the flow produced by said motors (50) when activated.

10. Unmanned aircraft according to one or more of the preceding claims, further comprising at least one tie rod or connecting element (41) for said aerodynamic container (40), said tie rod or connecting element (41) comprising a first portion, optionally a first end fixed to at least one between said first wing (11), said second wing (12), or an interconnection support (13, 14) and a second portion, distinct from said first portion and/or from said first end, optionally a second end opposite to said first end, fixed to said aerodynamic container.

11. Unmanned aircraft according to claim 10, wherein said interconnection supports (13, 14) are two and comprise a first interconnection support (13) and a second interconnection support (14), said first and second interconnection support being inclined, in particular being arranged orthogonally, with respect to said first wing (11) and second wing (12) and wherein said aerodynamic container (40) is positioned between said first wing (11), said second wing (12), and said first interconnection support (13) and said second interconnection support (14) and/or wherein said aircraft (1) takes a substantially box-like shape and/or defines a shape with two parallel sides, said sides being defined by said first wing (11), said second wing (12), said first interconnection support (13) and said second interconnection support (14), said first wing (11) being offset with respect to said second wing (12) and develops substantially on a plane parallel to the plane on which the second wing (12) substantially develops;
and wherein said first interconnection support (13) and/or said second interconnection support (14) integrate a set of wing profiles which are arranged at least partially in a condition of mutual proximity, optionally along a direction of advancement of said aircraft.

12. Unmanned aircraft according to one or more of claim 1-11, wherein said first and said second interconnection support (13; 14) each comprise a first portion, optionally a first end, fixed at a first end of the first wing (11) and at a second end of the first wing (11), respectively, opposite to the first end, and a second portion, optionally a second end opposite to the first end, fixed at a first end of the second wing (12) and at a second end of the second wing (12), respectively, opposite to the first end, and also comprising a plurality of tie rods or connecting elements (41) each having a first end fixed at a connection point between said first interconnection support (13) or said second interconnection support (14) and the respective portion or end of the first at the wing (11) or of the second wing (12), respectively, and a second end, opposite to the first end, fixed to said aerodynamic container (40), optionally in such a way that said aerodynamic container (40) takes a substantially central and/or substantially barycentric position between said first wing (11), said second wing (12) said first interconnection support (13) and said second interconnection support (14).

13. Aircraft according to one or more of the preceding claims, wherein said aerodynamic container (40) comprises a fixed central motor (50c), and wherein the central motor (50c) and/or said plurality of motors (50) comprise a plurality of electric motors whose rotor is fixed to a propeller (51), and wherein said at least one first and one second wing profile are positioned behind said propeller (51) with respect to a direction of advancement of said aircraft and/or wherein said propeller (51) is located at the front with respect to the leading edge of said first wing (11) and/or of said second wing (12).

14. Aircraft according to one or more of the preceding claims, wherein said first wing (11) and/or said second wing (12) comprise a first wing portion and a second overlapping wing portion, in particular overlapping along a direction substantially orthogonal to a direction of advancement and/or comprising at least one intrados or an extrados and wherein the overlap occurs along the direction substantially identified by an ideal line joining the intrados or extrados of the first wing portion with the intrados or extrados of the second wing portion; said first wing (11) and/or said second wing (12) each comprising a plurality of dividing walls, optionally equally spaced, interposed between said first and said second wing.

15. Aircraft according to one or more of the preceding claims, characterized in that it is a vertical take-off aircraft, and in that it comprises at least a first operating movement configuration substantially in vertical and/or hovering direction, in particular at take-off and/or at landing, and at least a second operating configuration of translated flight, wherein in said first operating configuration said direction of advancement is substantially vertical, and wherein in said second operating configuration the direction of advancement is substantially and/or comprises a longitudinal component.

16. Aircraft according to one or more of the preceding claims, wherein said first interconnection support and/or said second interconnection support (13; 14) integrate movable surfaces (13t, 14t) comprising ailerons or rudders or flaps and/or wherein said first or second wing (11, 12) integrate movable surfaces, wherein said movable surfaces (13t; 14t) are configured to modify the flow produced by said motors (50) when activated.

17. Aircraft according to claim 2, wherein said motors (50) are at least four, fixed, peripheral and controlled or controllable independently of each other, and at least one and more preferably each of said motors (50; 50c) has a variable pitch propeller (51), in particular variable between at least a first and smaller pitch and a second and greater pitch, and wherein in said first operating configuration said propeller (51) takes at least the first and smaller pitch and in said second operating configuration said propeller (51) takes the second and greater pitch.

18. Control method of an unmanned aircraft (1) according to one or more of the preceding claims, said method comprising:
an activation step of at least one motor (50) of a plurality of independently controllable motors (50) of said aircraft (1) in a first vertical take-off operating configuration or first flight attitude, starting from a support platform (101),
a step of adjusting the power generated by said plurality of motors (50) to cause a change of said first flight attitude in a further or second flight attitude identifying a second operating configuration of the aircraft (1) in which it proceeds in translated flight with a horizontal translation component,
wherein
the step of adjusting the power generated by said plurality of motors (50) causes an alteration of the spatial orientation of the structure of said aircraft (1);
and wherein said alteration of the spatial orientation of the structure of said aircraft (1) and/or the mutation between the first and the second attitude take place by means of motors (50) rigidly joined to the structure of said aircraft (1).

19. Method according to claim 18, comprising a control step of said second flight attitude wherein at least part of said motors (50) acts as an airbrake for said aircraft, optionally wherein said control step comprises an independent control of said motors (50).

20. Method according to claim 18, wherein said control step in which at least part of said motors acts as an airbrake comprises maintaining the rotation of the propeller (51) of each propeller used as an airbrake according to the direction of advancement of the aircraft and/or comprises a braking of the propeller (51) of each propeller used as an airbrake.

21. Method according to one or more of the preceding claims 17-19, comprising the control of the aircraft in said second flight attitude by means of a plurality of bridles connected at different points of the aircraft and in particular at end points of said first wing (11) and/or second wing (12), said plurality of bridles being connected to a first end of a retaining cable (18) fixed to a ground support at a predefined portion thereof, optionally at an opposite end thereof with respect to said first end.

22. Plant for the production of electricity, characterized in that it comprises:
at least one carriage (8) or a tracted device, movable along a guide (2) on a predefined path by means of the action of an aircraft (1) placed at altitude and subjected to the action of the wind;
a retaining cable (18) having a first portion configured to be connected to said aircraft (1) and a second portion connected to said carriage (8);
wherein said carriage (8) comprises electric generators (27, 28) adapted to produce electricity from the movement of said carriage (8) along said predefined path;
wherein said aircraft (1) is an aircraft according to one or more of the preceding claims 1-17.

23. Base for an unmanned aircraft (1), in particular for an aircraft according to one or more of claims 1-17, said base (100) comprising a support platform (101) for said aircraft (1) and a supporting frame adapted to space said support platform from the ground, said supporting frame comprising at least one base (103); said base being characterized in that said platform (101) is movable with respect to said base (103).

24. Base according to claim 23, wherein said platform (101) is movable by rotation relative to said base (103) and/or configured to take a plurality of controlled inclinations with respect to said base (103).

25. Base according to claim 24, comprising servoactuators configured to perform said rotation relative to the base (103) and/or to allow or cause the taking of a plurality of inclinations with respect to said base (103), wherein said actuators are configured to receive an actuation signal from wind meters, optionally from wind direction meters, and in particular to position said platform (101) upwind on the base of said actuation signal and/or according to at least one wind direction identified by said meters, said base further comprising a dome closure element, having at least one first open configuration and one second closed configuration, wherein in said first open configuration the closing element leaves the aircraft free to take off or land on the platform (101).

26. Base according to one or more of the preceding claims 23-25, further comprising a winch or drum (106) and a retaining cable (18) at least partially wound on said drum (106) and a motor (105) acting in rotation on said drum (106) for the controlled unwinding or rewinding of said retaining cable (18), said retaining cable (18) having in use at least one portion removably connected to said aircraft (1);
said base integrating a tubular element (107), optionally a telescopic tube (107), extending obliquely with respect to said platform (101) and on which and/or within which and/or with respect to which said retaining cable (18) is made to slide or slides;
said base (100) comprising an inertial measurement unit, positioned at or substantially at said tubular element (107), optionally at a free end of said tubular element (107), said inertial measurement unit being configured and/or specifically designed and/or adapted to detect forces and/or loads, in particular bending forces and/or loads, on said tubular element (107).

27. System for the production of electricity, characterized in that it comprises:
a base (100) according to one or more of the preceding claims 23 to 26,
an aircraft (10) according to one or more of the preceding claims 1 to 11,
a retaining cable (18) having a first portion configured to be connected to said aircraft (1);
a drum on which said retaining cable (18) is wound in a second portion thereof;
generating means for producing electricity, removably connected to said retaining cable (18) and/or to the drum on which said retaining cable (18) is connected, adapted to generate electricity from or through the unwinding and/rewinding of said retaining cable (18) on said drum by the action of a traction force, at least temporary, exerted by the aircraft (10) on said retaining cable (18),
said base (100) being installed in a fixed manner with respect to the ground and said retaining cable (18) being an electrically insulating cable.
